(19) United States
(12) Patent Application Publication
(10) Pub. No.: US 2024/0039086 A1
(43) Pub. Date: Feb. 1, 2024

(54) REFUELABLE BATTERY SYSTEMS, DEVICES, AND COMPONENTS

(71) Applicant: Form Energy, Inc., Somerville, MA (US)

(72) Inventors: Yet-Ming Chiang, Weston, MA (US); William Henry Woodford, Somerville, MA (US); Kailash Raman, Glendale, AZ (US)

(21) Appl. No.: 18/360,643

(22) Filed: Jul. 27, 2023

Related U.S. Application Data
(60) Provisional application No. 63/392,749, filed on Jul. 27, 2022.
(60) Provisional application No. 63/375,278, filed on Sep. 12, 2022.
(60) Provisional application No. 63/414,805, filed on Oct. 10, 2022.
(60) Provisional application No. 63/489,887, filed on Mar. 13, 2023.

(51) Int. Cl. H01M 12/08; H01M 4/62; H01M 4/04; H01M 8/04223; H01M 8/06; H01M 8/0662; H01M 12/02

(52) U.S. Cl. CPC H01M 12/08; H01M 4/628; H01M 4/0404; H01M 4/0452; H01M 8/04231; H01M 8/0693; H01M 8/0681; H01M 12/02; H01M 2220/20; H01M 2300/0068; B60L 50/60

(57) ABSTRACT

A metal-air battery including: a current collector; a metal electrode including a metal and contacting the current collector; an air electrode on the metal electrode and opposite the current collector; a solid electrolyte between the metal electrode and the air electrode; a discharge product of the metal on the air electrode; wherein the metal-air battery is configured to release the discharge product.

### CROSS REFERENCE TO RELATED APPLICATIONS

This application claims priority to U.S. Provisional Application No. 63/392,749 filed on Jul. 27, 2022; U.S. Provisional Application No. 63/375,278 filed on Sep. 12, 2022, 2023; U.S. Provisional Application No. 63/414,805 filed on Oct. 10, 2022; and U.S. Provisional Application No. 63/489,887 filed on Mar. 13, 2023, and all the benefits accruing therefrom under 35 U.S.C. § 119, the contents of which are incorporated by reference in their entireties.

### BACKGROUND

Batteries having high energy density or low cost are often non-rechargeable, have limited rechargeability, or insufficient specific energy. Thus, there remains a need for improved batteries or battery systems having an improved combination of energy density, specific energy, cost, and rechargeability for practical uses.

### BRIEF DESCRIPTION

Disclosed is a metal-air battery including: a current collector; a metal electrode including a metal and contacting the current collector; an air electrode on the metal electrode and opposite the current collector; a solid electrolyte between the metal electrode and the air electrode; a discharge product of the metal on the air electrode; wherein the metal-air battery is configured to release the discharge product.

Disclosed is an electric air vehicle system including: an electric air vehicle; and a metal-air battery including a current collector; a metal electrode including an alkali metal and contacting the current collector; an air electrode on the metal electrode and opposite the current collector; a solid electrolyte between the metal electrode and the air electrode; wherein the metal-air battery is configured to release the discharge product; and wherein the electric air vehicle is configured to emit the discharge product.

Disclosed is a method for converting a metal-air battery discharge product to a metal, the method including: providing a discharge product of a metal-air battery; contacting the discharge product with a liquid to form a brine; disposing the brine in an electrolysis cell including a solid electrolyte; electrodepositing a metal from the brine to convert the metal-air battery discharge product to a metal.

Disclosed is a method of collecting a discharge product of a metal-air battery, the method including: providing a metal-air battery configured to release a discharge product; flushing an air electrode of the metal-air battery with a gas stream to remove the discharge product from the air electrode and provide a discharge product entrained gas stream, or flushing an air electrode of the metal-air battery with liquid to remove the discharge product from the air electrode and provide a solution including the discharge product to collect the discharge product.

Disclosed is a method for processing a discharge product of metal-air battery, the method including: providing a discharge product from a metal-air battery; contacting the collected discharge product with water to form a brine including a metal ion of a metal of the metal-air battery; disposing the brine in an electrodeposition cell in contact with an electrolyte conductive to the metal ion; and reducing the metal ion on a current collector to form the metal of the metal-air battery and process the discharge product.

Disclosed is a method for manufacturing a metal-air battery, the method including: collecting a discharge product from a metal-air battery; contacting the collected discharge product with water to form a brine including a metal ion of a metal of the metal-air battery; disposing the brine in an electrodeposition cell in contact with an electrolyte conductive to the metal ion; reducing the metal ion on a current collector to form the metal of the metal-air battery on the current collector; and disposing an air electrode on the electrolyte to manufacture the metal-air battery, wherein the collecting includes the method of collecting a discharge product of the above-described metal-air battery.

Disclosed is a method for manufacturing a battery, the method including: collecting a discharge product from a metal-air battery; contacting the collected discharge product with water to form a brine including a metal ion of a metal of the battery; disposing the brine in an electrodeposition cell in contact with an electrolyte conductive to the metal ion; reducing the metal ion on a current collector to form the metal of the battery on the current collector; and disposing an electrode including an intercalation compound on the electrolyte to manufacture the battery.

Disclosed is a method for manufacturing a metal-air battery, the method including: providing a current collector; disposing a precursor to the solid electrolyte on the current collector; treating the precursor to form the solid electrolyte; contacting the solid electrolyte with a liquid containing metal ions of a metal of the metal-air battery; reducing the metal ions to electrodeposit the metal on the current collector; and disposing an air electrode on the electrolyte to manufacture the metal-air battery.

Disclosed is a method for manufacturing a metal-air battery, the method including: providing a current collector; disposing a solid electrolyte on the current collector; irradiating the solid electrolyte to densify the solid electrolyte; contacting the solid electrolyte with a liquid containing metal ions of a metal of the metal-air battery; reducing the metal ions to electrodeposit the metal on the current collector; and disposing an air electrode on the electrolyte to manufacture the metal-air battery.

Disclosed is an electric vehicle including the above-described metal-air battery.

Disclosed is a method of carbon sequestration, the method including: operating the above-described electric vehicle; contacting the air electrode with air to form the discharge product, wherein the air includes carbon dioxide, and the discharge product includes a carbonate, a bicarbonate, or a combination thereof; and emitting the discharge product to sequester the carbon.

Disclosed is a system including electrolysis cell for electrolytically producing a metal and a metal-air battery including the metal, the system including: a metal-air battery including a current collector, a metal electrode including a metal and contacting the current collector, an air electrode on the metal electrode, a first solid electrolyte between the metal electrode and the air electrode; and an electrolysis cell including a brine vessel configured to contain a brine including a metal ion of the metal, a second solid electrolyte between the brine vessel and the metal electrode of the metal-air battery, a cathode of the electrolysis cell on a side of the second solid electrolyte opposite the brine vessel, an anode of the electrolysis cell contacting in the brine vessel and opposite the second solid electrolyte.

Disclosed is a method for electrolytically producing a metal and using the metal in a metal-air battery, the method including: providing a system including a metal-air battery including a current collector, a metal electrode including a metal and contacting the current collector, an air electrode on the metal electrode, and a first solid electrolyte between the metal electrode and the air electrode, and an electrolysis cell including a brine contained in the brine vessel, the brine including a metal ion of the metal, a second solid electrolyte between the brine and the metal electrode of the metal-air battery, a cathode of the electrolysis cell on a side of the second solid electrolyte opposite the brine vessel, an anode of the electrolysis cell contacting in the brine and opposite the second solid electrolyte, providing a voltage between the cathode of the electrolysis cell and the anode of the electrolysis cell to transport a metal ion from the brine and form a metal of the metal ion on the cathode of the electrolysis cell; and contacting the air electrode with air to convert the metal on the cathode and in the air battery to a discharge product and use the metal.

Disclosed is a method of charging a metal-air battery, the method including: providing a metal-air battery including a solid electrolyte between an air electrode and a metal electrode, and a protective fluid on the metal electrode and opposite the solid electrolyte, wherein the protective fluid and the metal electrode are contained in a container having an upper inlet and a lower inlet; and adding the metal through at least one of the upper inlet or a lower inlet to charge the metal-air battery.

Disclosed is a method of operating a metal-air battery, the method including: providing a metal-air battery including a solid electrolyte between an air electrode and a metal electrode, and a protective fluid on the metal electrode and opposite the solid electrolyte, wherein the protective fluid and the metal electrode are contained in a container having an upper inlet and a lower inlet; and heating the metal to float the metal on the protective fluid, or cooling the metal to sink the metal in the protective fluid to operate the metal-air battery.

Disclosed is a system configured to thermochemically producing a metal, the system including: a metal salt including a discharge product of a metal-air battery; and a vessel configured to control pressure, temperature, atmosphere, or a combination thereof, wherein the vessel includes an inlet, an outlet, or both.

Disclosed is a method of thermochemically producing a metal, the method including: providing a metal salt; providing a vessel configured to control pressure, temperature, atmosphere, or a combination thereof, wherein the vessel includes an inlet, an outlet, or both; disposing the metal salt in the vessel; controlling the pressure, the temperature, the atmosphere, or a combination thereof, to thermochemically decompose the metal salt to produce the metal.

The above described and other features are exemplified by the following figures and detailed description.

### BRIEF DESCRIPTION OF THE DRAWINGS

The following figures are exemplary embodiments wherein the like elements are numbered alike:

FIG. 1A is a schematic cross-sectional view of a metal-air battery, such as a Li-air, or Na-air battery;

FIG. 1B is a schematic cross-sectional view of a metal-air battery, such as a Zn-air, or Fe-air battery;

FIG. 2A is a schematic cross-sectional view of a metal-air battery, in an initial charged state;

FIG. 2B is a schematic cross-sectional view of the metal-air battery of FIG. 2A, in a first charged state;

FIG. 2C is a schematic cross-sectional view of the metal-air battery of FIG. 2A, in a second charged state;

FIG. 2D is a schematic cross-sectional view of the metal-air battery of FIG. 2A, in a final charged state;

FIG. 3A is a schematic cross-sectional view of a metal electrode assembly in an initial assembly;

FIG. 3B is a schematic cross-sectional view of an aspect of the metal electrode assembly of FIG. 3A upon electrodeposition of metal;

FIG. 3C is a schematic cross-sectional view of another aspect of the metal electrode assembly of FIG. 3A upon electrodeposition of metal;

FIG. 3D is a schematic cross-sectional view of a metal-air battery including a metal electrode assembly including electrodeposition of metal and an air electrode;

FIG. 4 is a schematic illustration of a method of manufacture of a metal-air battery;

FIG. 5 is a schematic drawing of air vehicle powered by Na-air batteries using sodium oxide discharge product for carbon capture and sequestration (CCS) and ocean de-acidification;

FIG. 6 is a schematic cross-sectional view of a metal-air battery wherein the metal negative electrode comprises sodium, is optionally a liquid metal composition or semi-solid composition comprising sodium, and is contained within a vessel the walls of which comprise a solid electrolyte, and an air or CO₂ electrode is disposed on the exterior of said vessel;

FIG. 7 is a schematic cross-sectional view of a metal-air battery wherein the metal negative electrode comprises sodium, is optionally a liquid metal composition or semi-solid composition comprising sodium, and is excluded from a gas flow passage or channel by a vessel the walls of which comprise a solid electrolyte, an air or CO₂ electrode being disposed on the interior of said vessel;

FIG. 8 is a schematic cross-sectional view of a system comprising a metal-producing electrochemical cell integrated with or in proximity to a metal-air battery;

FIG. 9 is a schematic cross-sectional view of a system comprising a metal-air battery comprising a liquid sodium metal electrode floating on top of a non-reactive liquid of higher density than the liquid sodium;

FIG. 10A is a graph of density (grams per cubic centimeter, g/cm³) vs. temperature (K), showing the results of density of polydimethylsiloxane fluids of various average molecular weights and viscosities (units in centistokes, cSt) as a function of temperature;

FIG. 10B is a graph of polydimethylsiloxane (PDMS) density (grams per milliliter, g/mL) vs. 1/molecular weight (MW)×10³, showing PDMS density as a function of PDMS molecular weight;

FIG. 11A is a graph of density of mixtures of polydimethylsiloxane fluids of two average molecular weights and viscosities (units in centistokes, cSt) of 20 cSt and 1 cSt, as a function of temperature (K);

FIG. 11B is a graph of calculated thermal expansion coefficient of PDMS blends at 5° C. (αv, cm³/cm³° C.) vs. mass percent of 1 cSt in mixture;

FIG. 12 is a schematic cross-sectional view of reactive metal storage, handling and delivery system;

FIG. 13A is a graph of amount (arbitrary units, arb. units) vs. temperature (° C.), showing the temperature and pressure for decomposition of sodium oxides to sodium metal and oxygen; and

FIG. 13B is a graph of temperature (° C.) vs. pressure (Pascals, Pa), showing the temperature and pressure for decomposition of sodium oxides to sodium metal and oxygen.

### DETAILED DESCRIPTION

Batteries having high energy density and low cost are often non-rechargeable, or have limited rechargeability, and are often efficiently rechargeable only over a portion of the total capacity or state-of-charge of the battery, or have a short cycle life when recharged. Examples of high energy density batteries that are poorly rechargeable include metal-air batteries such as lithium-air (Li—air), sodium-air (Na—air), aluminum-air (Al—air), silicon-air (Si—air) batteries, or lithium carbon fluoride (Li—CFₓ) batteries. Although rechargeable lithium air batteries have been widely studied, they are not currently used in widespread applications. This is in part because achieving rechargeability has required the inclusion of costly components and more complex battery designs, and the addition of components enabling rechargeability (e.g., containment of the battery or purification of the air stream to allow a supply of clean oxygen) negates the energy density or specific energy advantage that Li—air may provide to a significant degree. Accordingly, while the potential for achieving improved energy density or specific has motivated interest in air batteries, poor rechargeability and the complexity and cost of providing for rechargeability has limited the practical use of such batteries.

To address the aforementioned challenges, disclosed are systems, devices, components, materials, methods of use, and methods of manufacturing, for batteries which are at least in part recharged or refueled by replacement of a negative or positive electrode-active material, or both. In particular, disclosed are systems and methods to enable the use of battery electrochemistries with attractive characteristics, such as high energy density, high specific energy, or low cost, and which heretofore have been regarded as being non-rechargeable, or poorly rechargeable, in applications needing a rechargeable battery. Disclosed are systems and methods to allow for fast recharging of a battery powered device or system. Accordingly, the recharging or refueling may be carried out by removing the battery from the device or system which it powers and replacing, e.g., exchanging the at least partially discharged battery with a charged battery. Disclosed are systems and methods to collect, purify, remediate, or process discharge products of the battery, which may be valuable, and to return the products to use in the battery or other applications, including battery applications similar to those generating the discharge product. Disclosed are systems and methods to provide an electrical power source that may be fed with a reactant comprising a metal, preferably an alkali metal, and from which the discharge product may be continuously removed, namely operating as a fuel-cell. Disclosed are systems and methods to use discharge products of the battery for the purpose of carbon dioxide capture or sequestration, or for the purpose of deacidifying, namely raising the pH, of an aqueous stream or body, including natural water bodies such as oceans, bays, or seas. In particular, disclosed is a metal-air battery that is rechargeable or refillable. In an aspect, the metal-air battery is designed to enable removal of a discharge product. In an aspect, the metal-air battery is designed to collect the discharge product of the metal-air battery. In an aspect, the discharge product is processed for reuse. In an aspect, a device or system comprises the metal-air battery. In an aspect, a charged metal-air battery is provided to the device or system.

Herein, “metal-air” batteries are understood to include as the “metal” any suitable chemical species which may be oxidized at an electrode of the battery when the battery is discharged, including without limitation alkali metals, alkaline earth metals, metal alloys, metalloids, such as Si or Ge, sulfur, boron, or phosphorus. At a counter electrode of the battery, molecular oxygen is reduced as the battery is discharged. Other variants of the metal-air battery include batteries wherein the species which is reduced at the air electrode (e.g., gas electrode) includes molecular species other than oxygen, and which may be supplied to the gas electrode as a gas or as molecular species dissolved in a liquid, including without limitation, carbon dioxide, carbon monoxide, nitrogen, nitrogen oxides, or sulfur oxides. As used herein, the term “air” refers to any suitable gas for use as an electrode active material in the metal-air battery, and may comprise oxygen, carbon dioxide, carbon monoxide, or air.

The battery may provide electrical power for a vehicle, which may be a ground, air or water vehicle. In an aspect, the battery comprises at least a part of the propulsion system for electric aircraft, including but not limited to a drone, vertical takeoff and landing (VTOL) passenger aircraft, fixed wing aircraft, and hybrids thereof. In an aspect, the battery comprises at least a part of the propulsion system for an automobile, bus, truck, or locomotive. The battery may also comprise at least a part of the propulsion system for a boat or ship. The battery may also provide stationary storage of electricity from any suitable generation source, including a renewable generation source such as a wind or a solar generator, for use by a stationary consumer of electricity including residential, commercial, or utility-scale consumer. The energy stored in such stationary electrical storage may vary from the kilowatt-hour to gigawatt-hour scale. The battery may provide emergency backup-power, for instance in the event of war or natural disasters which cause a loss of electricity supply, as stationary or transportable installations.

The disclosed systems include an electrically powered system comprising a battery that is electrically discharged or partially discharged in use, a system for recycling or rebuilding said battery to restore it to the charged state, and a system for providing said battery in its charged state back to the electrically powered system.

In an aspect, the battery is a primary battery, by which it is understood that the battery is electrically discharged and not electrically recharged. In an aspect, the battery is a secondary or rechargeable battery, and is electrically discharged and electrically recharged no more than five times, each recharge comprising the storage of electricity equal to the initial or nameplate capacity of the battery (e.g., in kilowatt-hours), before the battery is recycled or rebuilt.

The discharged battery may be recycled or rebuilt by removing the battery from the electrically powered system, recycling one or more of the electrodes of the battery, and supplying a newly built or rebuilt battery to the electrically powered system. Accordingly, regardless of whether the newly built or rebuilt battery directly uses the materials from the discharged battery which it replaces, at least a portion of the materials in the discharged battery are re-used for the same purpose, achieving materials “circularity.” In an aspect, the materials of the discharged battery are collected and used for other purposes, including for the manufacture of a different type of battery.

Electrochemical systems, battery types and compositions, and recycling and rebuilding methods of the battery are described herein.

### (1) Battery

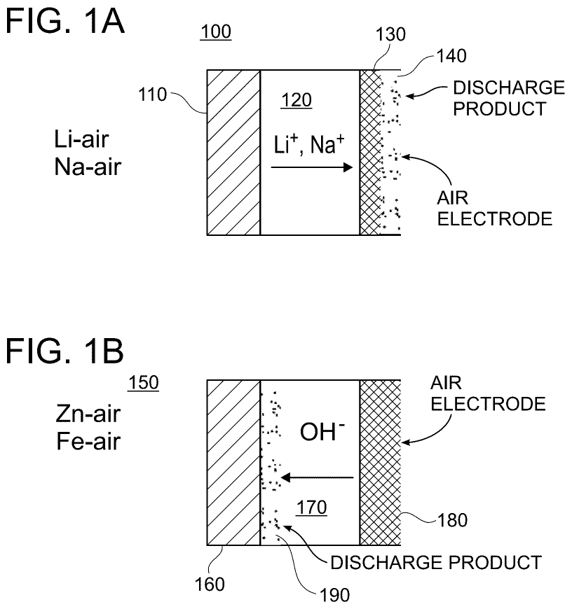

A metal-air battery has a metal electrode, an air electrode, and an electrolyte that provides for ionic communication between the metal and air electrodes. The metal electrode serves as the negative electrode of the battery cell, and the air electrode serves as the positive electrode. As shown in FIG. 1A, in a metal-air battery where the metal is an alkali metal such as lithium or sodium, the working ion is a lithium or sodium cation that transports between the metal and air electrodes. In further detail, as shown in FIG. 1A, a metal-air battery 100 comprises a metal electrode 110, an electrolyte 120, and an air electrode 130 opposite the metal electrode. The working ion, Li⁺ or Na⁺, transports in the electrolyte and a discharge product 140 forms on an outer surface of the air electrode opposite the electrolyte. Alternatively, the working ion may be an anion, as shown in FIG. 1B. As shown in FIG. 1B, the metal-air battery 150 comprises a metal electrode 160, an electrolyte 170, and an air electrode 180 opposite the metal electrode. The working ion, OH—, transports in the electrolyte and a discharge product 190 forms on a surface of the metal electrode and in the electrolyte. Examples include a Zn-air or Fe-air battery.

In an aspect the metal-air battery includes a configuration to provide for the removal of a discharge product. The discharge product may form at the air electrode. The air electrode (i.e., gas diffusion electrode) may include a gas diffusion electrode material, and the discharge product may form on the gas diffusion electrode material. In an aspect, the discharge product may form on a surface of the gas diffusion electrode material, may form on an outer surface of the gas diffusion electrode material, or may form on an interior of the gas diffusion electrode material. The gas diffusion electrode may comprise an active layer which may include catalysts, supported catalysts, and binders. In an embodiment, the active layer may be used to create a potential difference between the positive electrode and the negative electrode, when the cell is connected to the load. Accordingly, the gas diffusion electrode is positioned in the cell housing such that the active layer (and the active materials therein) faces the cell chamber and contacts the ionically conductive medium, whereby ions may be conducted through the ionically conductive medium to and/or from the metallic negative electrode. In some embodiments, the active materials of the active layer may be formed by a mixture of catalyst particles or materials, conductive matrix and solvophobic materials, sintered, layered, or otherwise bonded to form a composite material. In various embodiments, the active layer may be of any suitable construction or configuration, including but not limited to being constructed of carbon; fluoropolymers such as polytetrafluoroethylene (PTFE), perfluoroalkoxy alkane (PFA), fluorinated ethylene propylene (FEP), and/or polyvinylidene fluoride (PVDF); epoxies; conductive particles such as graphite, nickel, activated carbons, carbon fibers, carbon nanotubes, or graphene; fibers such as PTFE, polypropylene (PP), polyethylene (PE), SiO₂, or Al₂O₃; or any other suitable metal or alloy. In some embodiments, the active layer contains a catalyst for promoting the reduction of oxygen. This catalyst can be incorporated as independent particles or be supported on a conductive substrate, such as carbon black, activated carbon, or graphite, or other common catalysts such as platinum, platinum alloys, silver, silver alloy, manganese oxides, nickel, Raney nickel, nickel oxide, nickel hydroxide, nickel oxyhydroxide, cobalt oxide, perovskites, spinels, metal-nitrogen-carbon framework, heteroatom doped carbon, heteroatom doped carbon fibers, heteroatom doped carbon nanotubes, or heteroatom doped graphene.

In various embodiments a barrier layer serves as a backing material for the active layer. The barrier layer facilitates gas transport to the catalyst surfaces from the gas flow channels. Although the barrier layer may vary across embodiments, in some embodiments the barrier layer may comprise a fluoropolymer. As an example, in various embodiments, the barrier layer may comprise PTFE, which may in some embodiments be thermo-mechanically expanded (also known as ePTFE, or Gore-Tex®). In other embodiments, the barrier layer may comprise FEP, or any other fluoropolymer. The barrier layer may also be comprised of other binders such as polypropylene, polyethylene, polyamide, or an epoxy. In some embodiments, the barrier layer may contain other materials, including, but not limited to, carbon, graphite, nickel, steel, alumina, titania, to increase conductivity and/or structural strength.

Electrically coupled to the active layer or the barrier layer may be a current collector, which may be configured to receive electrons from a load for consumption by the oxygen reduction reaction when the cell is in a discharge mode. The current collector may be of any appropriate construction or configuration, including but not limited to being a screen or flow field. It may be appreciated that the metal screen current collectors conventionally have holes therein that are on the order of 50-2500 μm, but are preferably in the range of 100-1000 μm, and may in some embodiments be uniformly dispersed across its area. In various embodiments the current collector may be constructed of metals or alloys such as but not limited to nickel or nickel alloys including nickel cobalt, nickel iron, nickel copper (i.e. Monel), or superalloys, copper or copper alloys, aluminum or aluminum alloys, titanium or titanium alloys, brass, bronze, carbon, graphite, platinum, silver, silver-palladium, carbon steel, stainless steel, or any other suitable metal or alloy, plated or clad metals (i.e. nickel plated copper or other such combination of base metal and plated or clad metal).

In some embodiments the electrolyte is a solid electrolyte, and any one or more of the active layer, a current collector, or a barrier layer may be attached or bonded to said solid electrolyte. In particular embodiments said active layer may be electrically continuous, and also serves the function of a current collector. Such active layer may be porous or may be a substantially dense layer.

The metal-air battery may be a lithium-air, a sodium-air, a potassium-air, a calcium-air, a magnesium-air, an aluminum-air, a zinc-air, an iron-air, or a silicon-air battery. In some embodiments, a Li—air battery or a Na—air battery are particularly preferred.

In an aspect, the electrolyte includes the working ion of the metal-air battery, and the working ion may correspond to the metal of the negative electrode of the metal-air battery and be contained in the electrolyte of the metal-air battery. For example, the working ion may be Li⁺, Na⁺, K⁺, or Ca⁺.

### (2) Discharge Product Removal

Discharge of the metal-air battery results in oxidation of the metal of the negative electrode, resulting in the formation of one or more discharge products. As used herein, “discharge product” may be singular or plural. In an aspect, the metal of the negative electrode may be an alkali metal, such as lithium or sodium, and the discharge product is an oxidation product of the metal. The discharge product may be a hydroxide, an oxide, a peroxide, a carbonate, a bicarbonate, an oxalate, a peroxyoxylate, a halide of the metal, or a combination thereof. In an aspect, the discharge product for a nonaqueous Li—air or Na—air battery may include, for example, LiO₂, Li₂O₂, Li₂O, NaO₂, Na₂O₂ or Na₂O, or a combination thereof. Other gaseous reactants may also be used aside from oxygen, for example, a Li—CO₂ battery may form lithium bicarbonate, LiHCO₃, or lithium carbonate Li₂CO₃ at the gas electrode as a discharge product, and a Na—CO₂ battery may form sodium bicarbonate, NaHCO₃, or sodium carbonate Na₂CO₃ at the gas electrode as a discharge product. Other discharge products include metal oxalates, such as Li₂C₂O₄ or Na₂C₂O₄, or metal peroxyoxalates or peroxydicarbonates, such as Li₂C₂O₆ or Na₂C₂O₆. In an aqueous or nonaqueous-aqueous hybrid Li—air battery, the discharge product may be LiOH or its hydrates, which is at least partially dissolved in an aqueous electrolyte in contact with the air cathode. In contrast, for Zn-air and Fe-air, the electrolyte may be an alkaline solution, and during discharge, oxygen is reduced at the air cathode forming OH—ions, which react with the metal and may form Zn(OH)₄, which is highly soluble in the electrolyte, or Fe(OH)₂, which is largely insoluble. In these instances, the discharge product is produced at or near the metal electrode as it undergoes oxidation.

The discharge product may be soluble in a liquid. The liquid may be aqueous or nonaqueous. In an aspect, the discharge product may be soluble in water, and the liquid may comprise water, and may be an aqueous solution. In some embodiments, the discharge product may be soluble in a nonaqueous solvent, such as a C₁ to C₄ carbonate, a C₁ to C₄ alcohol, a C₁ to C₄ ketone, or a combination thereof, and may form a nonaqueous solution in the nonaqueous solvent. The discharge product may be soluble in an ionic liquid. For example, the discharge product of a lithium air battery may be lithium fluoride, and the ionic liquid may be an aluminum-alkali metal chloride, e.g., a chloroaluminate ionic liquid, such as an ionic liquid having a melting point below 100° C., e.g., 10° C. to 200° C., or 20° C. to 150° C.

In an aspect, the discharge product may form at the negative electrode and may be removed by dissolution in a liquid to form a solution, and the solution may be removed from the metal-air battery. A non-limiting example is a Zn-air battery, wherein the discharge product includes a zincate ion, e.g., ZnO₂²⁻. The zincate ion is soluble in an alkali solution, and may be dissolved to form an alkaline solution, and the solution including the zincate ion may be removed from the metal-air battery, e.g., to be discarded or for collection for later processing, as described herein.

The metal-air battery may be configured for removal of one or more discharge products from the negative electrode after discharge of the metal-air battery. In an aspect, the discharge product of the metal-air battery may be collected while the metal-air battery remains installed in the device or system which it powers.

In an aspect, the air electrode of the metal-air battery may be flushed with a fluid, such as a gas stream, to remove the discharge product from the air electrode. The gas stream may include an inert gas that is substantially non-reactive or inert with respect to the discharge product. Representative inert gases include, but are not limited to, nitrogen, argon, helium, hydrogen, or a combination thereof. The gas stream may include a reactive gas that is reactive with the discharge product. Representative reactive gases include water (steam), carbon monoxide, carbon dioxide, or a combination thereof. The gas stream may be a mixture of nitrogen and oxygen, or may comprise air.

The gas stream may be pumped, or may transport from natural convection, such as thermal convection, to produce the gas flow. The temperature and composition of the gas stream may be selected to provide a suitable rate of removal of the discharge product from the metal-air battery. For example, the humidity, the partial pressure of water, the dew point, the temperature, or a combination thereof of an air stream may be selected (increased or decreased) to select the rate at which a discharge product, e.g., a metal oxide, a metal peroxide, or a metal superoxide discharge product is removed, or a rate at which the discharge product is contacted with the reactive gas to form a secondary product, such as a metal hydroxide, and removed. In some embodiments, a water partial pressure may be between about 0.001 and 1 atmosphere. Similarly, a partial pressure of carbon dioxide and/or the temperature of a gas stream including air may be selected to select a rate of formation of a metal carbonate discharge product and its rate of removal. In some embodiments a carbon dioxide partial pressure may be between about 0.0003 ppm and about 1 atmosphere.

In an aspect, the air electrode may be flushed with a liquid to remove the discharge product. The liquid may be aqueous or non-aqueous, and may dissolve or suspend the discharge product to form a mixture, suspension, or solution. Representative aqueous liquids include water, and representative nonaqueous liquids include a C₁ to C₄ carbonate, a C₁ to C₄ alcohol, a C₁ to C₄ ketone, or a combination thereof. Optionally, the air electrode may be flushed with another fluid to further process the electrode. For example, the other fluid may be dry air, and the air electrode may be flushed with dry air to dry the air electrode.

The air electrode may be configured to provide a gas or liquid flow velocity, a direction, and a suitable combination of laminar and turbulent flow (that is, a Reynolds number). The air electrode may have any suitable configuration of channels, passages, venturi, constrictions, patterns, or a combination thereof, to provide a suitable velocity or a direction of gas or liquid flow. In some embodiments, a gas flow velocity may be between about 0.1 meter per second (m/sec) and about 500 msec. In some embodiments, a liquid flow velocity may be between about 0.001 msec and about 100 msec. The air electrode may be corrugated, or may have adjacent to it a flow field including channels, passages, and/or other patterns to control the flow of the gas or the liquid during operation.

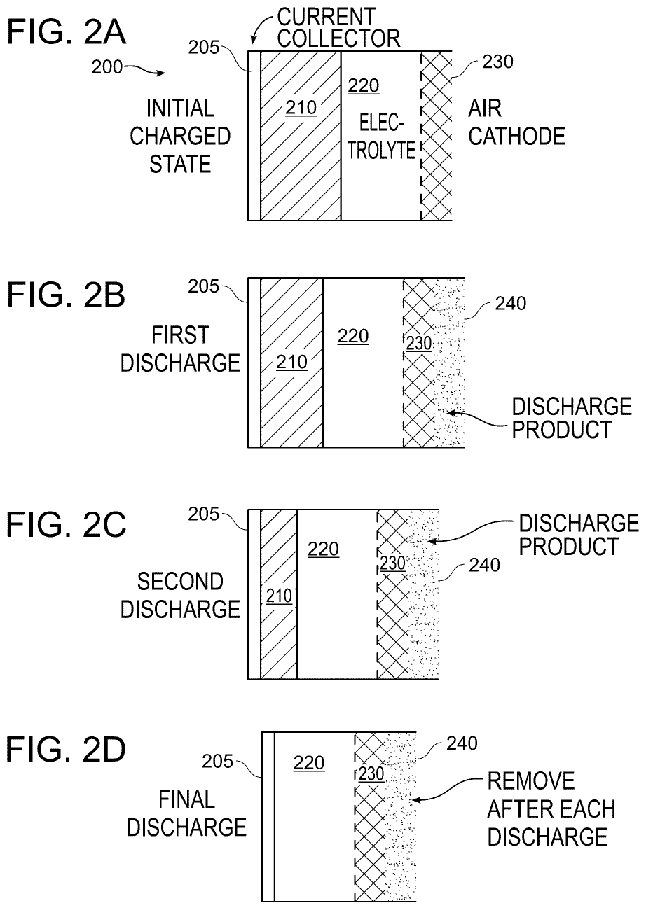

The removal of discharge products from the metal-air battery may occur at any suitable state of charge of the battery. In an aspect, the discharge products may be removed when the metal-air battery is substantially (e.g., completely) discharged. In an aspect, the discharge products may be removed when the metal-air battery is partially discharged. FIG. 2A shows a metal-air battery 200 in an initial charged state having a current collector 205, a metal electrode 210, an electrolyte 220, and an air electrode (e.g., air cathode) 230. As shown in FIG. 2A, the discharge product may not be present. FIG. 2B shows the metal-air battery 200 after a first discharge and shows the discharge product 240 formed on the air electrode. The content of the metal electrode 210 shown in FIG. 2B is less than the content of the metal electrode in the initial state shown in FIG. 2A, as some of the metal has been converted to the discharge product 240. FIG. 2C shows the metal-air battery 200 after a second discharge and shows the discharge product 240 formed on the air electrode. The content of the metal electrode 210 shown in FIG. 2C is less than the content of the metal electrode after the first discharge shown in FIG. 2B, as more of the metal has been converted to the discharge product 240. FIG. 2D shows the metal-air battery 200 after in a discharged state and shows the discharge product 240 formed on the air electrode. The metal electrode 210 has been entirely converted to the discharge product 240.

As also indicated in FIG. 2D, the discharge products may be removed after a first discharge, after a second discharge, after a final or complete discharge, or a combination thereof. If the metal-air battery is completely discharged, the metal negative electrode, and optionally other components, may also be replaced before the metal-air battery is again discharged. The metal-air battery may be configured to undergo cycles of partial discharge followed by collection of the discharge product. The discharge product may be removed continuously, or intermittently.

An advantage of having a configuration wherein the discharge product may be removed continuously or intermittently allows for an operating mode in which the loss of power and capacity due to the accumulation of a discharge product can be mitigated in between discharge cycles. Another advantage is that the metal electrode or entire metal-air battery may be replaced at less frequent intervals while obtaining high discharge power due to removal of the discharge product. In some embodiments, the process and rate of removal of the discharge product may be selected so as to allow the metal-air battery to maintain a desired discharge power. For example, convective removal of discharge product may occur at a higher rate when high discharge power is indicated, and at a lower rate, or not at all, when low discharge power is indicated.

### (3) Discharge Product Collection

In an aspect, the discharge product of the metal-air battery may be collected by removing one or more components from the metal-air battery, collecting the discharge product from the component, and replacing the one or more components in the battery. For example, the component that is removed may be a positive electrode, a negative electrode, or both, of the metal-air battery. As a specific, non-limiting example, the air electrode of a Li—air or Na—air battery may be removed, the discharge product may be flushed to remove the discharge product from the air electrode, the air electrode may be returned to the component, and the metal-air battery may be placed back in service. As another example, the positive electrode of a Li—CFₓ battery may be removed after discharge, the LiF discharge product may be removed by dissolution in a suitable liquid, and the positive electrode may be replaced or returned to service. In an aspect, the suitable liquid may be any suitable liquid capable of dissolving the LiF discharge product, e.g., an aqueous hydrofluoric acid solution, or a metal halide melt, such as one comprising AlCl₃. As another example, a metal electrode including a discharge product may be removed from the metal-air battery, the discharge product may be removed by dissolving the discharge product in a suitable liquid, the metal electrode replaced in the metal-air battery, and the metal-air battery returned to service. In an aspect, the suitable liquid may be any suitable liquid capable of dissolving the discharge product.

### (4) Processing the Discharge Product

In an aspect, the metal of the metal-air battery may be an alkali metal or an alkaline earth metal, and the collected discharge product may include an oxidation product of the alkali metal or the alkaline earth metal, such as an oxide, a peroxide, or a hydroxide of the alkali metal or the alkaline earth metal. The discharge product may be a feedstock in a process producing the alkali metal, the alkaline earth metal, or an alloy thereof. In an aspect, the aqueous solution (e.g., solution) may include metal ion, e.g., Li⁺, Na⁺, or Ca⁺, containing solutions. As a non-limiting example, a lithium oxidation product, such as lithium hydroxide, lithium oxide, lithium carbonate, lithium bicarbonate, lithium oxalate, or a combination thereof, may be dissolved in an aqueous solution to provide a lithium brine. The lithium brine may then be used as a feedstock for a process producing lithium metal or a lithium metal alloy. Analogous sodium oxidation products and processes for producing sodium metal are also known. Sodium oxidation products include, but are not limited to, sodium hydroxide, sodium oxide, sodium carbonate, or a combination thereof. The brine of the alkali metal or the alkaline earth metal (i.e., the brine, for example, lithium brine, or sodium brine) may have the advantage of being significantly more concentrated, or of a higher purity, than a natural brine. In an aspect, the brine may have a concentration of 0.01 to 10 molar (M), 1 to 8 M, or 3 to 5 M of the alkali metal or the alkaline earth metal. In an aspect, the content of an impurity, i.e., a metal other than the alkali metal or the alkaline earth metal, may be 1 to 1000 parts per million (ppm), 10 to 500 ppm, or 50 to 100 ppm. In a particular embodiment, the brine may be used as a feedstock for the electrochemical deposition of the metal through an electrolyte that conducts an ion of the metal. Such electrolyte may be a solid electrolyte, or a molten salt such as a mixture of alkali metal or alkaline earth metal halides including those of lithium or sodium. The solid electrolyte may be a solid polymer electrolyte or a solid inorganic electrolyte. The solid inorganic electrolyte may be a ceramic. In an aspect, the solid inorganic electrolyte may include NaSICON, LiSICON, Na-β″-alumina, K-β″-alumina, lithium phosphate (Li₃PO₄), lithium titanium phosphate (LiₓTi_{y}(PO₄)₃, 0<x<2 and 0<y<3), lithium aluminum titanium phosphate (LiₓAl_{y}Ti_{z}(PO₄)₃, 0≤y≤1, and 0<z<3), Li_{1+x+y}(AlₐGa₁₋ₐ)ₓ(Ti_{b}Ge_{1-b})₂₋ₓSi_{y}P_{3-y}O₁₂ (0≤x≤1, 0≤y≤1, 0≤a≤1 and 0≤b≤1) lithium lanthanum titanate (LiₓLa_{y}TiO₃, 0<x<2 and 0<y<3), lithium germanium thiophosphate (LiₓGe_{y}P_{z}S_{w}, 0<x<4, 0<y<1, 0<z<1 and 0<w<5), lithium nitride (LiₓN_{y}, 0<x<4, and 0<y<2), a LiₓSi_{y}S_{z}, glass (0<x<3,0<y<2, and 0<z<4), a LiₓP_{y}S_{z}, glass (0<x<3, 0<y<3, and Li₂O, LiOH, Li₂CO₃, LiAlO₂, Li₂O—Al₂O₃—SiO₂—P₂O₅—TiO₂—GeO₂ type ceramics, garnet-type ceramics (Li₃₊ₓLa₃M₂O₁₂(M=Te, Nb, Zr)), or a combination thereof. In an aspect, the solid polymer electrolyte may include a lithium salt and a polymeric ionic liquid comprising poly(diallyldimethylammonium trifluoromethanesulfonyl)imide (TFSI), poly(1-allyl-3-methylimidazolium trifluoromethanesulfonyl imide), poly(N-methyl-N-propylpiperidinium bis(trifluoromethanesulfonyl)imide), or a combination thereof. In an aspect, the solid polymer electrolyte may include a lithium salt and an ion conducting polymer comprising polyethylene oxide (PEO), polyvinyl alcohol (PVA), polyvinylpyrrolidone (PVP), polyvinylsulfone (polysulfone), polypropylene oxide (PPO), polymethyl methacrylate, polyethyl methacrylate, polydimethylsiloxane, polyacrylic acid, polymethacrylic acid, polymethyl acrylate, polyethyl acrylate, poly 2-ethylhexyl acrylate, polybutyl methacrylate, poly 2-ethylhexyl methacrylate, polydecyl acrylate, polyethylene vinyl acetate, phosphate ester polymer, polyester sulfide, polyvinylidene fluoride (PVDF), Li-substituted Nafion, or a combination thereof.

Additional details of processes for producing lithium or sodium metal, or lithium or sodium containing products from the feedstock are known to those skilled in the art of harvesting and purifying alkali metal bearing brines, for example brines sourced from natural geological sources.

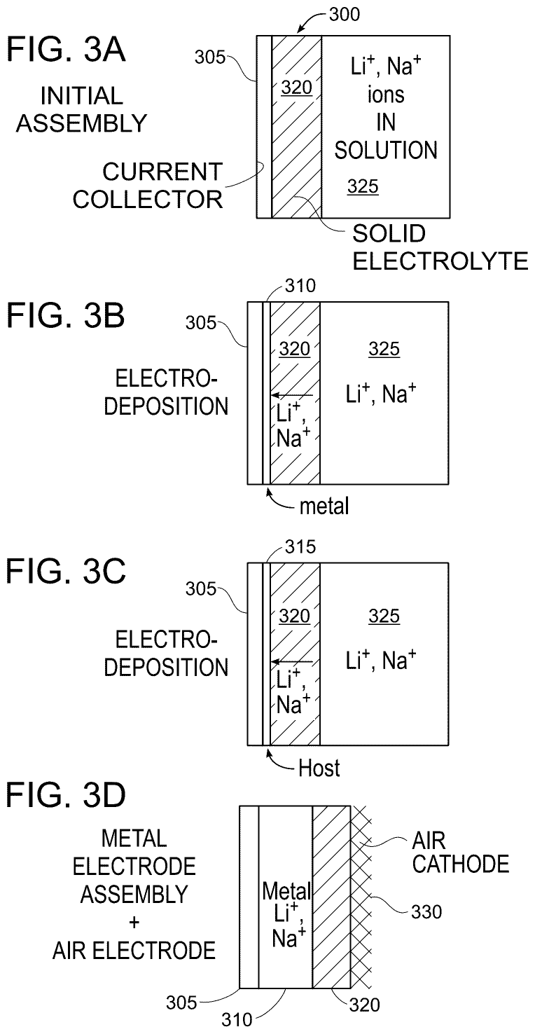

As illustrated in FIG. 3A to 3D, the brine, such as the alkali metal or the alkaline earth metal brine, such as a lithium or sodium brine, may be used as the feedstock for producing the corresponding metal by electrodepositing the metal, e.g., the alkali metal or the alkaline earth metal, such as lithium or sodium, from the brine through an electrolyte onto a metal current collector. In further detail, and as shown in FIG. 3A, a current collector and electrolyte assembly 300 comprising a current collector 305 and an electrolyte 320 may be contacted with a brine 325, which is a solution comprising the alkali metal or alkaline earth metal cation i⁺, such as Li⁺ or Na⁺ The electrolyte may be a solid electrolyte, the solid electrolyte may be disposed on the current collector, and the brine may be prepared from battery discharge product.

Next, as shown in FIG. 3B, the metal 310 may be electrodeposited on the current collector 305 on a surface facing the electrolyte 320, e.g., between the current collector and the solid electrolyte, from the brine 325 to provide a current collector-metal electrode or current collector-metal electrode-electrolyte, or metal electrolyte-electrolyte subassembly. The subassembly may be used to provide a metal-air battery. The metal-air battery may be provided by disposing a suitable metal, such as Li, Na, K, Ca, Mg, Zn, Fe, or Al, on the current collector on the surface on which the metal is deposited. The brine may comprise lithium or sodium to provide a lithium-air battery or a sodium-air battery.

Alternatively, as shown in 3C, the collected discharge products of the metal-air battery may be used to form the brine, and the alkali metal or alkaline earth metal cation from the brine may be transported through a solid electrolyte and incorporated into a host 315 to form an intercalation compound that reversibly stores the metal. Many intercalation compounds are known to those skilled in the art of metal ion batteries, such as Li-ion or Na-ion batteries, that can reversibly incorporate an alkali metal and hence may be used as the positive or negative electrode of a rechargeable battery. The host may subsequently be used as the electrode of a battery. Alternatively, the metal, e.g., an alkali metal, can be recovered from the intercalation compound by deintercalation. For example, a liquid phase compound, such as compositions used as the liquid electrolyte in metal-ion batteries, can also be used. Such liquids may comprise, for example, alkyl carbonates. Additional details of the solid or liquid phase compounds capable of storing the alkali metal, such as intercalation oxides, are known to those skilled in the art of primary and rechargeable lithium and sodium batteries.

### (5) Battery Comprising the Processed Discharged Product

The electrodeposited metal may be used to provide a metal electrode assembly of the metal-air battery, as shown in FIG. 3D. The metal electrode assembly may comprise the current collector 305 and the electrodeposited metal 310 on the current collector. In the battery, also present is an electrolyte, such as electrolyte 320, and an air electrode 330 on the electrolyte. The electrolyte 320 in the metal-air battery may be the same or different than that of the electrolyte used in electrodeposition. Thus the discharge product of a metal-air battery may be subsequently used in its metallic form in the metal electrode of the metal-air battery. The metal electrode may be used in a subassembly including a current collector and an electrolyte on the current collector, and depending on the state of charge, the metal-air battery may further include the metal electrode disposed on the current collector.

The metal may comprise Li, Na, K, Ca, Mg, Zn, Al, or a combination thereof. The discharge product may be an oxide, a hydroxide, a carbonate, a bicarbonate, an oxalate, or another metal compound, and the discharge product may be subsequently refined or processed, for example to produce a metal salt utilizing a different anion than that of the discharge product, prior to production of the metal.

As a non-limiting example, the discharge product may be converted to a halide of the metal, such an alkali metal halide or an alkaline earth metal halide, and the metal halide used to produce the metal. In further detail, an electrolytic or electrochemical method may be used to produce the metals from the metal halide. Non-limiting examples of such methods include the electrolytic decomposition of a metal halide to the metal and the halogen. In some embodiments, the metal halide is a chloride. For example, lithium chloride (or sodium chloride) may be electrolytically decomposed to form lithium metal (or sodium metal) and chlorine gas, respectively. Other metal chlorides such as calcium chloride or magnesium chloride may be similarly decomposed. Also, an additional metal halide, including but not limited to an aluminum chloride, a tin chloride, an alkali metal chloride, an alkaline earth chloride, or a combination thereof may be added to reduce the melting temperature of the chloride mixture. For example, mixtures of an aluminum chloride, such as AlCl₃, with LiCl, NaCl, KCl, or the like, or a combination thereof, have lower melting temperatures than the pure metal chloride end-members, being known to form binary and ternary and multinary eutectic compositions. Similarly, mixtures including calcium chloride, CaCl₂, with LiCl, NaCl, KCl, or a combination thereof, may form a eutectic mixture with lower melting point liquid compositions than the melting points of the pure salts. Accordingly, mixtures of metal chlorides may allow lower electrolysis temperatures for deposition of a constituent metal from the metal chloride mixture. The metal chloride mixture may include a liquid, a solid, or a semi-solid including at least one each of a liquid composition and a solid composition. Chlorine gas or, for other metal halides, or a corresponding halogen gas, produced by the electrolytic decomposition may be used to make chlorinated products as part of the contemplated system. Thus the disclosed subsystems may include a system for producing metals or metal electrodes by such methods.

In some embodiments, the halide mixture may be used to produce metal electrodes for the metal-air battery by electrodepositing the metal directly onto a current collector. For example, the negative electrode of the metal-air battery may be produced at least in part by electrodeposition of the metal onto the current collector of the battery. Alternatively, the halide mixture may be used to produce a metal electrode for use in the metal-air battery by electrodepositing the metal through an electrolyte as shown in FIG. 3B. In an aspect, the electrolyte 320 of an electrolyte layer may include a solid electrolyte, a liquid electrolyte, a gel electrolyte, or a combination thereof. Use of a solid electrolyte is mentioned. Thus, the described system provides for producing metals or metal electrodes by such methods.

In an aspect, the discharge product may be used for other purposes and the metal electrodes of the metal-air battery may be produced from other starting materials (not derived from the discharge products). For example, the metal halide electrolysis processes described herein for producing the metal may include as a feedstock material a metal halide that is sourced elsewhere (i.e., not from a discharge product of the metal-air battery). For example, a mixture including LiCl and CaCl₂, from which Li metal may be electrolytically produced, may be obtained from a mined source or from a recycled source other than the discharge product of the metal-air battery. Similarly, a mixture including NaCl and CaCl₂, from which Na metal is electrolytically produced, may be sourced from other than the discharge product of the metal-air battery, or may be from a recycled source other than the discharge product of the metal-air battery. Such materials and methods may have economic and supply chain advantages. Such methods may allow for use of a less pure and less costly source of the metal halide, such as NaCl and/or CaCl₂) obtained from seawater, a desalination brine, or a geological or industrial brines, such as a brine from the extraction of oil or natural gas, for producing the metal. In such instances, the discharge product of the metal-air battery may be of higher purity and greater market value and may be used in applications requiring higher purity, including for producing Li-ion and Na-ion cathode materials or solid electrolytes. In an aspect, the discharge product of the metal-air battery may have a purity of 80 to 99.9999 weight percent (wt %), 85 to 99.99 wt %, or 90 to 99.9 wt %, based on a total weight of the discharge product.

The brine produced from the discharge product of the metal-air battery may be used to produce lithium negative electrode material or sodium negative electrode material by electrochemical insertion or alloying. For example, the negative electrode material may be provided by intercalating the metal from the brine into graphite, hard carbon, silicon, tin, another host such as aluminum, or a metal oxide. In an aspect, lithium or sodium may be combined with carbon or silicon to provide negative electrode material for the metal-air battery.

The discharge product may be concentrated to provide a metal salt for sale or use. For example, LiOH and Li₂CO₃ may be used as starting materials for the production of lithium ion battery cathode materials such as LiFePO₄, LiCoO₂, lithium nickel-cobalt-aluminum oxide (NCA), lithium nickel-manganese-cobalt oxide (NMC), or lithium manganese oxide (LMO). Alternatively, LiOH and Li₂CO₃ can used as starting materials for the production of lithium ion battery anode materials, such as lithium titanate spinel (LTO), a lithium conducting solid electrolyte such as lithium lanthanum zirconium oxide (LLZO), or a lithium superionic conductor (LiSICON). NaOH and Na₂CO₃ may be similarly used for the production of a sodium ion battery cathodes and sodium solid electrolytes. Variants and derivatives of these compounds are known to those skilled in the art. Analogous compounds may be used to provide a sodium ion battery electrode and a sodium ion conducting solid electrolyte, e.g., NaSICON, or a sodium beta-alumina solid electrolyte. Lithium salts, sodium salts, or other metal salts collected as discharge products may be used in the production of such electrodes or electrolyte materials.

### Negative Electrode

The negative electrode of the metal-air battery may include any suitable metal. The metal may be an alkali metal, an alkaline-earth metal, a transition metal, a metalloid, a post-transition metal, or a combination thereof. In some embodiments, the negative electrode may be an alkali metal or an alkaline earth metal. The alkali metal may be Li, Na, K, Rb, Cs, or a combination thereof, and the alkaline earth metal may be Mg, Ca, or a combination thereof. The transition metal may be iron, zinc, or the like, or a combination thereof. The post transition metal may be aluminum or the like. The metalloid may be silicon or the like. A combination including at least one of the foregoing may be used.

For example, a metal of the negative electrode of the metal-air battery may include zinc, iron, or aluminum, the metal-air battery may be a zinc-air, iron-air, or aluminum-air battery, and the discharge product may form at the air electrode.

### Electrolyte

The electrolyte of the metal-air battery may be any suitable liquid, may be aqueous or nonaqueous, or may be an ionic liquid. In an aspect, the metal-air battery may include an alkaline electrolyte and may be configured such that the discharge product forms on the air electrode (i.e., gas diffusion electrode), on a surface of the gas diffusion electrode material, on an outer surface of the gas diffusion electrode material, or on an interior of the gas diffusion electrode material. The aqueous electrolyte may include a hydroxide, such as an alkali metal hydroxide, such as lithium hydroxide, sodium hydroxide, potassium hydroxide, or a combination thereof, in water. The nonaqueous electrolyte may include a nonaqueous liquid, such as a C₁ to C₄ carbonate, a C₁ to C₄ alcohol, a C₁ to C₄ ketone, or a combination thereof, and any suitable salt, such as lithium borate, or the like. The ionic liquid may be an aluminum-alkali metal chloride, e.g., a chloroaluminate ionic liquid, such as an ionic liquid having a melting point below 100° C., e.g., 10° C. to 200° C., or 20° C. to 150° C.

In an aspect the electrolyte may be a solid electrolyte. The solid electrolyte may be selected to conduct selected metal ion(s). The solid electrolyte may conduct lithium, sodium, aluminum, zinc, iron, or a combination thereof. The solid electrolyte may include solid polymer electrolytes (SPEs) having suitable lithium or sodium conductivity, such as a conductivity equivalent to polyethylene oxide (PEO) doped with a lithium salt such as lithium chloride. Copolymers and copolymers blends, including block copolymers, including PEO may also be used. The SPEs may be deposited on the current collector using any suitable process, such as a casting, coating, spraying, vapor deposition, or the like. In some embodiments, casting a liquid solution including the SPE, or deposition of a vapor including the SPE, may be used. Other representative methods to dispose the SPE on the current collector include solvent casting, melt casting, dip coating, extrusion, co-extrusion, slot-die coating, spray coating, electrostatic spraying, electrophoretic deposition, ink jet deposition, three-dimensional printing, or the like, or a combination thereof. The SPEs may be disposed in the form of a liquid solution, a melt phase, liquid droplets, dry solid, or dry powder.

The solid electrolyte may include an inorganic solid electrolyte. Non-limiting examples include lithium ion and sodium ion conducting solid electrolytes, such as inorganic solid electrolyte having a garnet-type structure, such as lithium lanthanum titanium oxide (LLTO, e.g., Li₇La₃Zr₂O₁₂), doped variants of LLTO (e.g., LLZTO, Li_{6.75}La₃Zri₇Ta_{50.25}O₁₂), or derivatives thereof, or compositions or structures within the lithium superionic conductor (LiSICON) or sodium superionic conductor (NaSICON) families. As used herein, the term “garnet” or “garnet-type” means that the compound is isostructural with garnet, e.g., Mg₃Al₂(SiO₄)₃. For example, the solid electrolyte may include a beta-alumina, including sodium and/or potassium beta-alumina (e.g., (Na—β″—Al₂O₃ or (K—β″—Al₂O₃), sulfides such as lithium phosphorus sulfide (β—Li₃PS₄, LPS) or lithium germanium phosphorus sulfide (LGPS), antiperovskites such as Li₃OX or Li₂OHX, wherein X is a halogen, or compounds containing cluster ions such as those including NH₂, BH₄, or PS₄ groups, e.g., Na₃₋ₓO₁₋ₓ(NH₂)ₓ(BH₄) where 0<x<1, Li₃₋ₓO₁₋ₓ(NH₂)ₓ(BH₄) where 0<x<1, or an argyrodite material, e.g., a stoichiometric or a nonstoichiometric argyrodite material such as Li₆PS₅X, Li₆₋ₓPS₅₋ₓX₁₊ₓ, or Li₆₊ₓSiₓP₁₋ₓS₅X, where X is a halogen, such as Cl, Br, or I, and 0<x<1.

### Current Collector

The current collector may include any suitable electrical conductor, and may include a transition metal, a metalloid, a post-transition metal, or a combination thereof. For example, the current collector may include copper, iron, titanium, zinc, aluminum, silicon, or a combination thereof. The current collector may include carbon, including graphitic carbon, glassy carbon, amorphous carbon, soot, carbon black, graphene, graphene oxide, carbon nanofibers, carbon nanotubes, or the like, or a combination thereof. In some embodiments, the current collector may include an electronically conductive polymer, such as poly(3,4-ethylene dioxythiophene) (PEDOT). The current collector may include any suitable electronically conductive inorganic compound, such as a metal oxide, a metal carbide, a metal nitride, a metal oxycarbide, a metal oxynitride, or the like, or a combination thereof. Examples of such compounds include, but are not limited to, a copper oxide, a vanadium oxide, a tin oxide, a titanium carbide, a titanium nitride, or the like, or a combination thereof.

The term “electronically conductive” is understood to mean that the current collector material at its temperature of use has an electronic conductivity of greater than 10⁻⁶ Siemens per centimeter (S/cm), preferably greater than 10⁻³ S/cm, more preferably greater than 1 S/cm, and still more preferably greater than 10³ S/cm, or 10⁻⁶ S/cm to 10³ S/cm, or 10⁻³ S/cm to 10³ S/cm.

### Methods

Also provided is a method to manufacture the subassembly of the metal-air battery. In an aspect, the current collector, the metal electrode, and the solid electrolyte may be provided separately and joined to provide the subassembly of the metal-air battery. The metal electrode may be disposed on the current collector, and the solid electrolyte may be disposed on the metal electrode, e.g., in a roll-to-roll process, to join the current collector, the metal electrode, and the solid electrolyte, and to provide the subassembly of the metal-air battery. Any of the current collector, the metal electrode, the solid electrolyte, and/or a sacrificial material such as a release film, may serve as a support or substrate upon which the current collector, the metal electrode, and/or the solid electrolyte are deposited, to provide the subassembly of the metal-air battery.

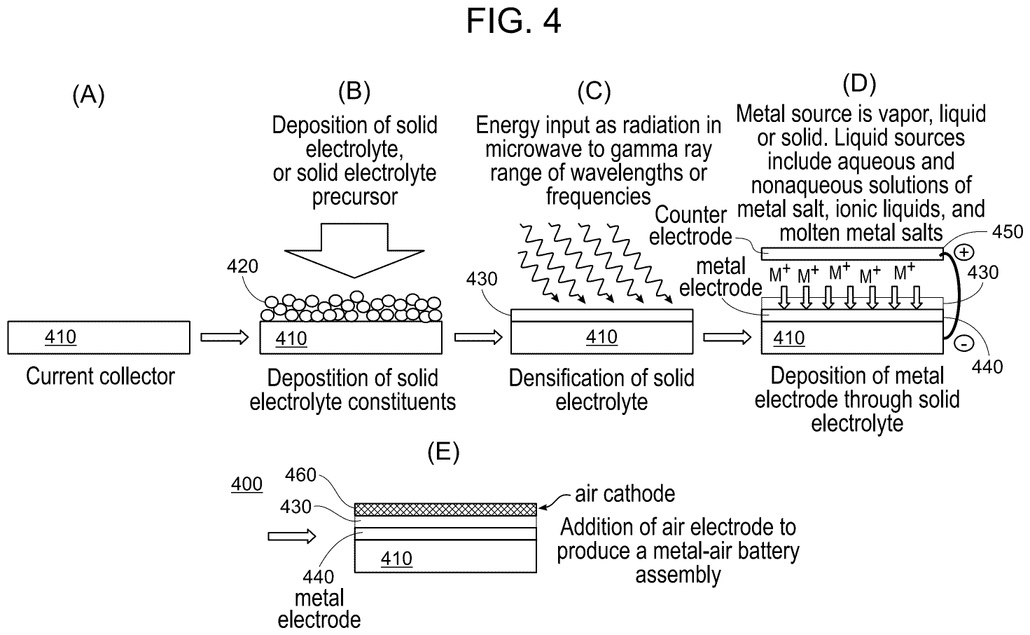

A method of manufacture is shown schematically in FIG. 4.

First, as shown in FIG. 4, step (A), a current collector 410 is provided. The current collector may comprise any suitable conductor, and may comprise a metal, polymer, ceramic, composite, or a combination thereof, having suitable properties, such as suitable conductivity.

Second, as shown in FIG. 4, step (B), the solid electrolyte, or a solid electrolyte precursor 420 is disposed on the current collector from a suitable vapor phase, liquid phase, or solid phase source. Such precursors may comprise metal salts which upon heating decompose to leave behind components of the solid electrolyte. Such metal salts may comprise metal nitrates, sulfates, carbonates, oxalates, acetates, and alkoxides. In an aspect, the solid electrolyte is disposed from a suitable vapor phase, liquid phase, or solid phase source. The solid electrolyte may be deposited in the form of particles, or may be deposited in the form of a layer as shown in FIG. 4, step (C). Alternatively, a solid electrolyte precursor may be deposited in the form of particles. In an aspect, a layer comprising particles of the solid electrolyte precursor is formed. The particles may be formed by deposition of a precursor that is subsequently converted to the solid electrolyte. In a non-limiting example, an aqueous solution, a nonaqueous solution, or a suspension of a metal nitrate, sulfate, carbonate, oxalate, acetate, alkoxide, or a combination thereof may be used to provide the particles, e.g., using sol-gel chemistry to form a particle layer. Other methods to deposit the precursor and provide the particles include chemical vapor deposition, e.g., chemical vapor deposition of the precursor to the solid electrolyte; electrophoretic deposition of particles from a liquid suspension; electrochemical deposition, for example electrochemically creating a pH change adjacent to the current collector to promote metal hydroxide precipitation or electrocoagulation occurs; electrostatic coating of the current collector with droplets, mist, or vapor of a composition including the precursor to the solid electrolyte; or coating, such as spray coating or dip coating a suspension including the precursor to the solid electrolyte on the current collector. The foregoing methods are representative, and other methods known to those skilled in the art of coating, or roll-to-roll processes, as well as curing methods, such curing with ultraviolet or electron irradiation, are also mentioned. Additional details of the foregoing methods may be determined by one of ordinary skill in the art without undue experimentation.

Third, as shown in FIG. 4, step (C), the precursor of the solid electrolyte is treated to provide the solid electrolyte 430. As initially deposited, the solid electrolyte may be in the form of a dense continuous layer or a porous continuous layer. Treatment of a porous material may be desired to increase density and provide a dense material. The treatment may include heat treatment, e.g., heat treatment at 100° C. to 1000° C., 200° C. to 800° C., or 300° C. to 700° C. The precursor may be contacted with any suitable radiation, from microwave to gamma rays, to convert the precursor to the solid electrolyte and/or densify the solid electrolyte. Alternatively, in some embodiments, the precursor of the solid electrolyte may be contacted with a plasma to convert the precursor to the solid electrolyte.

Optionally, additional processing may be used to alter the composition or structure of the solid electrolyte. For example, the solid electrolyte may be treated with radiation or heating during or after it is deposited. Representative methods for treating the deposited solid electrolyte include radiative heating, convective heating, microwave heating, plasma heating, or the like, or a combination thereof. The treating may include treatment in an oven or furnace, with or without a conveying device. The radiation source may provide radiation of any suitable frequency and/or wavelength. The radiation may include microwave, infrared, visible, near-ultraviolet, ultraviolet, X-ray, gamma ray, or a combination thereof. The radiation may include electrons or photons. The heating may include heating at any suitable rate, and may include rapid heating methods, the details of which may be determined by one of skill in the art. Representative rapid heating methods include microwave heating, plasma heating, spark plasma sintering, flash sintering, rapid thermal processing (RTP), rapid thermal annealing (RTA), UV sintering, blacklight sintering, or the like, or a combination thereof. Such methods, in particular blacklight sintering, are described in “Blacklight sintering of ceramics” by L. Porz, et al., Materials Horizons, DOI:10.1039/d2mh00177b, published 2022; and “Microstructure and conductivity of blacklight-sintered TiO₂, YSZ, and Li_{0.33}La_{0.57}TiO₃” by L. Porz, et al., Journal of the American Ceramic Society, DOI: 10.1111/jace.18686, published 2022, the entire contents of which are incorporated by reference herein.

In some aspects, the solid electrolyte may be initially present as a porous or an incompletely dense layer, and is densified further, e.g., using one or more of the above described methods, to produce a substantially densified layer, preferably with closed porosity or having a density at least 80% of the theoretical density of the compound including the solid electrolyte, preferably exceeding 90% of the theoretical density, preferably 85% to 99.9999%, or 90 to 99.99% of the theoretical density. The densified layer may have an average thickness of 1 nanometer (nm) to 1 millimeter (mm), preferably 10 nm to 100 micrometers (μm), or preferably 1 μm to 50 μm. The thickness and average thickness may be determined by microscopy, such as scanning electron microscopy, of cross sections of the solid electrolyte layer.

The densified layer may have a density gradient, or multiple layers having different densities may be used. For example, the densified layer may include a first densified layer adjacent to a second less dense layer of the solid electrolyte. An example of such densified layer adjoining a less dense layer is shown in FIGS. 4a and 4e of “Microstructure and conductivity of blacklight-sintered TiO₂, YSZ, and Li_{0.33}La_{0.57}TiO₃,” by L. Porz, et al., incorporated by reference in its entirety for all purposes.

Next, as shown in FIG. 4, step (D), a metal electrode layer 440 is introduced between the current collector and the solid electrolyte 430 by transport of metal ions through the solid electrolyte layer followed by reduction to form the metal electrode between the current collector and the electrolyte. Also shown is counter electrode 450. The counter electrode may comprise any suitable material, and may comprise and may comprise a metal, polymer, ceramic, composite, or a combination thereof, having suitable properties, such as suitable conductivity and materials compatibility, e.g., materials compatibility with the brine or metal halide.

Such deposition may be produced by having a chemical potential gradient between the current collector and the source of metal atoms such that the metal chemical potential is lower at the current collector. Such deposition may also be produced by applying an electrical potential between the current collector and a counter electrode located apart from the current-collector—solid electrolyte subassembly, resulting in an electrical potential gradient causing migration of metal ions from the source of metal through the solid electrolyte to the current collector, and reduction to form the metal electrode 430, as illustrated in FIG. 4, step (D). The source from which the metal is electrodeposited may include one or more of the previously mentioned sources of the metal, such as a brine or a metal halide.

Next, as illustrated in FIG. 4, step (E), an air electrode 460 is disposed on the metal electrode. In an aspect, specifically on a subassembly including a current collector, a metal negative electrode, and a solid electrolyte may be provided, and the air electrode disposed thereon to provide the metal-air battery 400.

### Recharge

The metal-air battery may be mechanically recharged by replacing the negative electrode subassembly with a subassembly having a greater amount of the metal. As discussed above with reference to FIGS. 3A to 3D, as the metal air battery is discharged the metal is converted to discharge product. The metal air battery may be recharged by replacing the discharged current collector-metal electrode-electrolyte subassembly with a subassembly having a greater amount of the metal. Also, the metal may be provided by processing the discharge product, e.g., collecting the discharge product, forming a brine, and electrodepositing the discharge product on the current collector, to provide a recharged current collector-metal electrode-electrolyte subassembly. The mechanical recharging may comprise replacing a discharged subassembly with the recharged subassembly. In an aspect, the mechanical recharging may be performed while the metal-air battery remains in the system or device it powers, and components, e.g., the current collector-electrolyte subassembly, or current collector may be replaced. In other embodiments, the metal-air battery may be removed and refurbished, rebuilt, or remanufactured before being returned to service. In other embodiments, the discharged metal-air battery may be recycled or disposed of after at least a portion of the discharge product is collected therefrom, and a newly manufactured metal-air battery may be used in its place.

Subsystems or methods of providing a charged metal-air battery also include systems or methods configured to provide and distribute charged batteries to the powered devices and systems. A “charging station” for such purposes may include a facility wherein collected discharge product, discharged components, and/or metal-air batteries undergo processing of the discharge product to fabricate the metal electrode or the subassembly in a “charged” state having the metal to provide charged battery cells. The facility may exchange a discharged subassembly for a charged subassembly, may remove a discharged subassembly from a battery, may install a charged subassembly, or may distribute components such as electrodes, batteries, or battery systems to the powered devices or systems.

Such facilities for processing of the discharge product and manufacturing of the components or batteries for a charged battery system may be located within or at the point of use of the metal-air battery. Non-limiting examples include a service hub, e.g., for a fleet of cars, buses, trucks, and/or trains. Other examples include the integration of such facilities at an airport for electrified aircraft, or onboard a ship using such batteries.

### Device: Vehicle

The exceptionally high energy density and low materials cost of metal-air batteries, in particular alkali metal-air batteries, is attractive for hybrid and electric aviation, amongst other applications. Without wishing to be bound to theory, a limitation of metal-air batteries where the discharge product is retained is that the discharge reaction increases the mass and volume of the battery. For example, Li metal increases in mass by a factor of 5.61 upon oxidation to LiO₂, and Na metal increases in mass by a factor of 2.39 upon oxidation to NaO₂. Accordingly, the battery mass increases as the metal-air battery is discharged, which may reduce the range and load capacity of a vehicle powered by the battery. In contrast, vehicles powered by petroleum fuels, e.g., gasoline, diesel, or propane, lose mass as the fuel is combusted. In the disclosed system, a metal-air battery, method of use, and metal-air battery powered vehicle are provided that mitigates this deficiency. In the disclosed system the air electrode of the metal-air battery may be configured so that natural convection or forced convection removes the discharge product from the electrode. The discharge product, thusly removed, may be discarded from the vehicle as the vehicle is propelled.

In an aspect, the discharge product may optionally sequester a greenhouse gas or other pollutant while it resides in the air electrode, as it is removed from the air electrode, or after it has been removed from the air electrode.

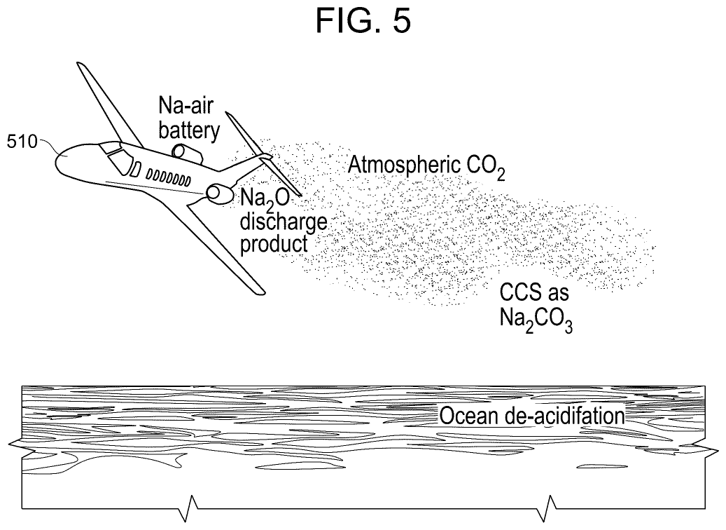

In a selected aspect, a metal-air battery may be used to power an electric air vehicle. Mentioned is an aspect where the metal is an alkali metal. Use of a sodium-air battery is mentioned. As illustrated in FIG. 1, the discharge product of a Na—air battery may accumulate at the air electrode. In the air vehicle the discharge product is removed. As shown in FIG. 5, the air vehicle, as it flies, may experience air flow or natural convection that may be directed, for example through the use of a funnel or flow field having channels such that the air flow is directed to the air electrode to remove the discharge product. The air flow may pass adjacent to the air electrode, over the air electrode, or through the air electrode, to remove at least a portion of the discharge product. The air flow may also be produced, at least in part, using forced convection, for example by a fan or turbine to direct the air. The fan or turbine may be at least partly powered by the metal-air battery.

As shown in FIG. 5, the discharge product is removed by the air flow and ejected or discarded from the air vehicle 510. In the instance of a Na—air battery, the discharge product may subsequently react with carbon dioxide (CO₂) in the air, forming, for example, a carbonate such as Na₂CO₃, or, if water is present, a bicarbonate such as NaHCO₃The carbonate may form while the sodium discharge product is in the air electrode of the battery, after discharge product is discharged, as the discharge product falls to earth through the atmosphere, or after the discharge product lands. In an aqueous medium, said discharge product will eventually form bicarbonate, and therefore each mole of Na that is discharged from the battery will react with one mole of CO₂. Because the metal reacts with air to form a carbonate, e.g., sodium metal is converted to sodium carbonate or sodium bicarbonate, the discharge product of the battery may have capture and sequestered CO₂ from the atmosphere, also known as direct air capture (DAC), performing a beneficial function for the environment and society. The carbonate may further perform a beneficial function of increasing the alkalinity of a water body, such as the ocean, if the carbonate lands in or is otherwise transported to the water body.

In an aspect where the discharge product of the battery is not collected, use of a low-cost metal, such as sodium, is preferred. Also, in addition to the value provided in propelling the vehicle, there may be an economic return from the capture and sequestration of a greenhouse gas such carbon dioxide, such as through a price on the captured carbon. As an illustration of the operational model which may be included, disclosed is a system and process wherein NaCl is a starting material and is electrolytically reduced to Na metal. Not including the value of Cl₂ gas that may be co-produced, the cost of producing the Na metal, including the cost of the NaCl feedstock, may be about $0.44 per kilogram (kg). For a Na—air battery with an average discharge voltage of 2 volts (V), and using Na₂O as the discharge product, complete oxidation of the Na metal produces electricity at a cost of $0.19 per kilowatt-hour (kWh). Upon carbonation to Na₂CO₃, and using a CO₂ price of $100 per ton, the return for capturing and sequestering CO₂ is $0.08 per kWh, resulting in a net cost of delivered electricity for the battery system of $0.11 per kWh. The $0.11 per kWh net cost is comparable to the cost of delivered electricity of other batteries of much lower energy density than the Na—air battery. It is, for example, comparable to the cost of delivered electricity for a Li-ion battery with a cycle life of 1000 cycles, or $110 per kWh. $0.11 per kWh net cost is also comparable to the cost of propelling an aircraft using jet fuel.

In an embodiment, a metal-air battery includes a metal electrode that is at least in part a liquid. The liquid may comprise any suitable metal, and may comprise an alkali metal, an alkaline earth metal, or a combination thereof, preferably an alkali metal, more preferably sodium metal. In a non-limiting example, the alkali metal may be sodium. At an operating temperature of the metal-air battery, the metal electrode may be a liquid sodium alloy, and example of which is an Na—K alloy, or may be a semi-solid electrode having at least one liquid metal and one solid phase. Liquid sodium has a melting temperature of about 98° C. Without wishing to be bound to theory, an advantage of having a metal electrode that is a liquid alloy or a semi-solid metal may be that the operating temperature of the metal-air battery may be reduced. In an aspect, a Na—K composition is selected that provides a liquid including Na at a temperature below the melting temperature of sodium metal. For example, as shown in a Na—K binary phase diagram, a Na—K alloy having about 69 mole percent (mol %) potassium may be a liquid at a temperature of −13° C., corresponding to a eutectic composition and temperature of the Na—K alloy. For a Na—K compositions having 33 mol % to 97 mol % potassium, based on a total content of the alloy, a liquid of the eutectic composition may be present in the electrode at a temperature greater than the eutectic temperature of the alloy. In the disclosed Na—K electrode composition, and for a temperature above the eutectic temperature, the negative electrode may be a semi-solid electrode having a solid Na₂K phase co-existing with a Na—K liquid, or a K-rich solid phase co-existing with a Na—K liquid. For Na—K compositions having less than about 40 mol % potassium, and at a temperature above 7° C., the Na—K negative electrode may be a single liquid phase, or may be a semi-solid electrode including a solid sodium-rich phase co-existing with a Na—K liquid.

The operating temperature of the metal-air battery may include a wide range of temperatures from below room temperature (e.g., 25° C.), for example at temperatures as low as —commensurate with the Arctic zone, or even less as found in space or in extraterrestrial environments, to temperatures well above room temperature, for example high temperature batteries operating at up to 200° C., 300° C., 500° C., 1000° C., or even greater. Accordingly, in the instance of a sodium-air or lithium-air battery, as non-limiting examples, the operating temperature of the battery may be below the melting point of sodium metal (approximately 98° C.) or of lithium metal (approximately 180.5° C.) such that the metal is solid during operation of the battery, or may be above the melting point of either metal, such that the metal is liquid during operation of the battery.

The metal-air battery may include a solid electrolyte. Any suitable solid electrolyte may be used. Representative solid electrolytes, such as garnet, a beta-alumina, and anti-perovskite, an argyrodite, a NaSICON electrolyte, or a combination thereof, are mentioned. Suitable solid electrolytes are further described above.

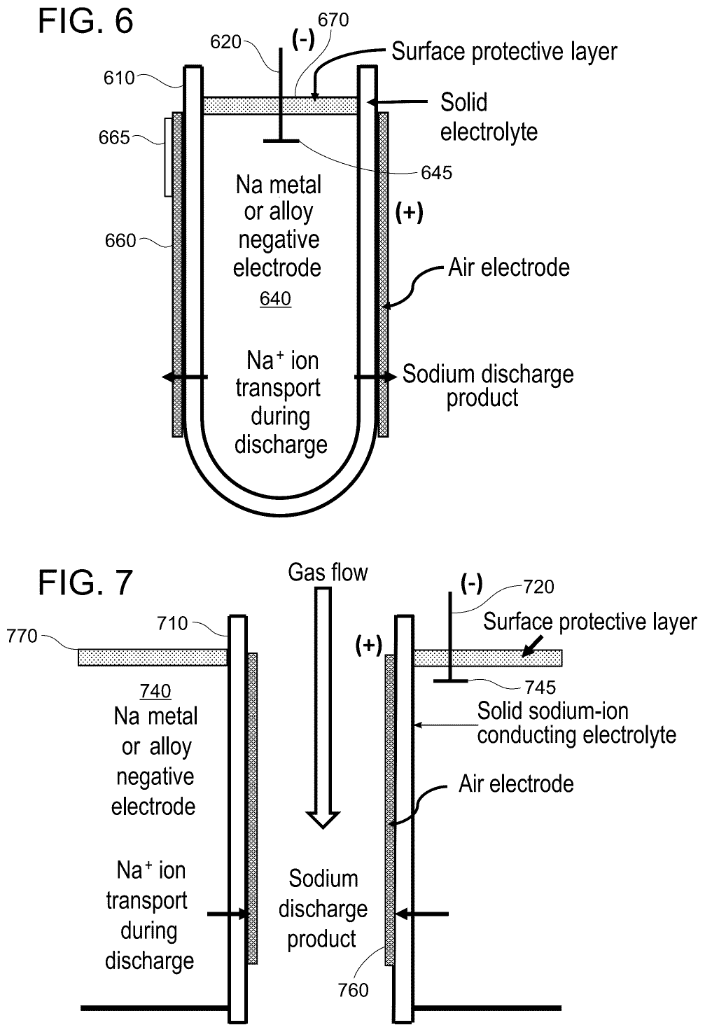

The solid electrolyte may be in the form of a vessel 630 within which resides the metal electrode 640. As illustrated in FIG. 6, the vessel 630 may have any suitable shape, may be rectilinear or curvilinear, spherical, or cylindrical, and may be in the form of a closed-end tube. The tube may have any suitable cross-sectional shape, the cross-section may be rectilinear, curvilinear, rectangular, square, circular, or elliptical. Any suitable cross-sectional shape may be used. The tube may have a cross-sectional shape having a perimeter to area ratio that is greater than a such geometric shape. Also, the vessel may have a height or length to width or diameter ratio that is greater than one, to provide a tube, or less than one, to provide a tray or box shape, and may have a surface area to volume ratio that is greater than a geometric shapes, for example by including a corrugated or reticulated wall, for example.

The metal-air battery may further include a negative lead 620 in electrical communication with, and optionally in physical contact with, the metal electrode 640. In an aspect, the negative lead is connected to the current collector 645 of the metal electrode. Also provided is a positive lead 665, the positive lead in electrical communication with the air electrode 660. The metal electrode may be disposed on an inside or concave surface of the vessel. The air electrode may be located on the exterior or convex surface of the vessel. The air electrode may allow for the electrochemical reaction of metal ions it, such as Lit or Na⁺, transported through the solid electrolyte with oxygen, carbon dioxide, carbon monoxide, nitrogen, a nitrogen oxide, or a combination thereof.

Also provided is protective layer (e.g., surface protective layer) 670. The protective layer protects the metal electrode to prevent or avoid reaction with air. The protective layer may be disposed on the metal electrode, and may protect the metal electrode from reaction with the surrounding ambient atmosphere. The protective layer may comprise a liquid, a non-limiting example being an organic liquid having limited reactivity when in contact with the metal electrode, and which limits the transport of air or water to the negative electrode. In an aspect the metal of the metal-air battery, present as a solid or a liquid, may be combined with an inert liquid to provide easier and safer handling, storage, or delivery of the metal to the power-producing battery. The liquid is preferably non-reactive to the metal. The liquid may be hydrophobic or hydrophilic, and may be wetting or non-wetting to the surface of the metal. In a preferred embodiment, the liquid is non-reactive and wetting to the surface of the metal, i.e., having a contact angle between the liquid and the metal of 0° to 90°, 5° to 80°, or 10° to 70°. Non-limiting examples of the liquid include hydrocarbon oils, silicone oils, organic or ionic liquids, polymers, emulsions, gels, suspensions of particles in liquids, or the like.

In specific embodiment where the metal electrode includes an alkali metal, the liquid may include a hydrophobic compound such as an oil, such as mineral oil or a petroleum-derived hydrocarbon liquid. In an aspect where the metal electrode comprises lithium, sodium, potassium, or an alloy thereof, the protective layer may comprise mineral oil, and may be effective to preclude reaction of the metal electrode with air. The metal-air battery may have a configuration that is opposite from that illustrated in FIG. 6, namely having the metal electrode on the exterior or concave surface of the vessel and the air electrode on the interior or convex surface of the vessel.

The vessel may be open-ended. As shown in FIG. 7, the vessel 710 comprises a solid electrolyte, is in the form of a tube, and may provide for a fluid, such as air, to flow through the vessel. The metal electrode 740 may be disposed on an outside of the vessel 710, and discharge product may form at an air electrode 760. Also shown in FIG. 7 is protective layer (e.g., surface protective layer) 770, e.g., mineral oil, the negative current collector 745, and the negative lead 720. In FIGS. 6 and 7, a preferred embodiment in which the metal is sodium is indicated, although any suitable metal or metal alloy can be used.

The metal-air battery may include a vessel, including the configurations illustrated in FIGS. 6 and 7. Also, the metal-air battery may include an array of vessels, and the vessels may be close-ended or open-ended tubes, and may further comprise any suitable combination of channels connected in any suitable configuration, but configurations are not limited thereto.

The metal electrode may be produced from a metal salt using a solid electrolyte electrochemical cell. In some embodiments, the solid electrolyte electrochemical cell may include a solid electrolyte having an ionic transference number for a selected metal of the metal electrode, that is greater than about 0.9, preferably greater than 0.95, and preferably greater than about 0.99, and still more preferably greater than 0.999, or 0.9 to 0.99999, or 0.95 to 0.9999. That is, the solid electrolyte may be effectively a single ion conductor, and may advantageously provide for a metal electrode having a purity which corresponds to the ionic transference number. In an aspect, the transference number is 0.999, and a metal having a purity of 90% to 99.999%, 95 to 99.99%, or about 99.9 mol %, based on a total metals content of the metal, may be produced for use in the metal-air battery.

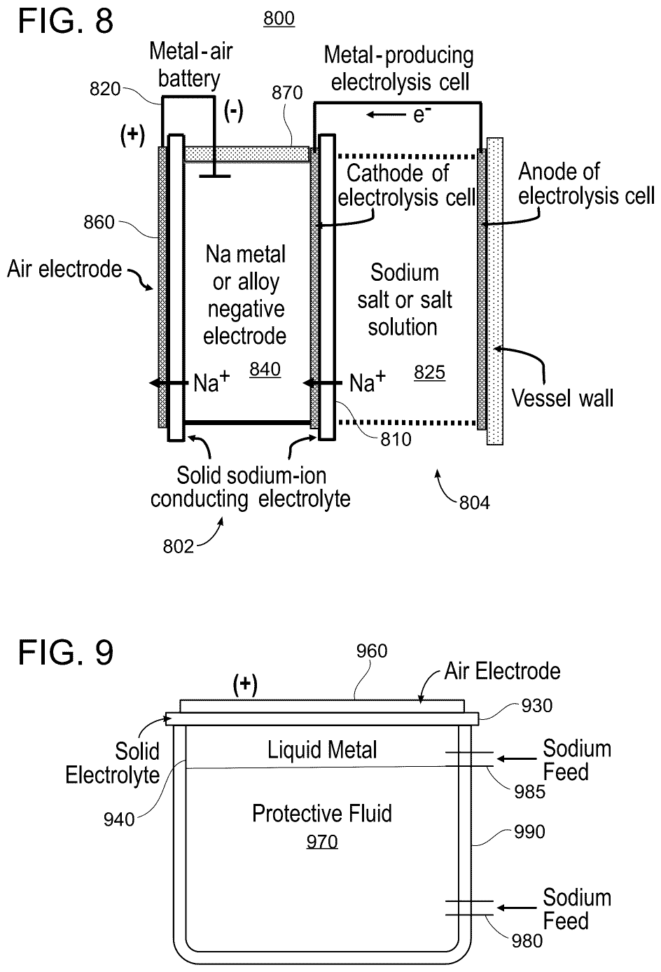

The metal-air battery may be combined with an electrolysis unit having the solid electrolyte to provide a combined system having the metal-air battery and the electrolysis unit. The metal-air battery may be integrated with the electrolysis unit (e.g., metal-producing electrochemical cell) as shown in FIG. 8. The integrated system 800 comprises a metal-air battery subunit 802 and an electrolysis subunit 804. Said metal-producing electrochemical cell uses input electricity to produces at least a metal from a feedstock material, and said metal may then be used as the negative electrode of a metal-air battery. Included in the metal-air battery subunit is a negative lead 820 connected to a current collector 845. Protecting the metal electrode 840 is the protective layer 870. In the integrated system shown in FIG. 8, the metal ions transport from the electrolysis subunit to the metal-air battery subunit through the wall of the vessel 810 comprising the solid electrolyte. The discharge product 860 may form at the air electrode 860. The electrolysis unit may contain a brine 825 comprising the metal ion corresponding to the metal of the metal electrode.

The solid electrolyte of the integrated system may comprise a single solid electrolyte, or may comprise any suitable combination of solid electrolytes. Because the solid electrolyte may selectively transport metal ions, and have a transference number of greater than about 0.9, preferably greater than 0.95, and preferably greater than about 0.99, and still more preferably greater than 0.999, or 0.9 to 0.99999, or 0.95 to 0.9999, the solid electrolyte may be selected to produce a selected metal or selected combination of metals, e.g., selected combination of metals for an alloy. For example, the electrolysis cell 804 may contain a brine 625 comprising a metal salt as the metal source in the brine. The metal salt may comprise more than one alkali metal salt, for example, a lithium salt and a sodium salt. Accordingly, the solid electrolyte of the vessel 810 of the electrolysis cell may include both a lithium-conducting solid electrolyte and a sodium-conducting solid electrolyte, and may be operated to produce both high purity lithium and high purity sodium, in proportions selected by the relative rates of production of the individual metals through each solid electrolyte. For example, the product of current and operating time through each solid electrolyte may be used to determine the time-averaged absolute amount of each metal that is produced, which may be subsequently used alone or as a mixture or alloy with one or more other elements.

Any suitable combination of metal salts may be used in brine 825 in the electrolysis cell to produce the high purity metal. A metal hydride; a metal halide such as a metal chloride, metal bromide, or a metal fluoride; a metal chalcogenide such as a metal sulfide or a metal selenide; a metal carbonate; a metal oxide; or a combination thereof may be used in electrolysis cell. The metal salt may be a liquid or a solid. As a non-limiting example, a mixture of sodium chloride and calcium chloride may be used to lower the melting point of the mixture compared to sodium chloride alone. A sodium-ion solid electrolyte, such as sodium beta alumina or NaSiCON, may be used as the solid electrolyte in the electrolysis cell, allowing the electrochemical production of high purity sodium metal. As sodium is depleted from the mixed sodium-calcium chloride, NaCl may be added to maintain a desired composition of the source material in the electrolysis cell. Simultaneously with sodium metal reduction, chloride ion oxidation to chlorine may take place. The chlorine co-product from the cell may be advantageously used to produce a chlorinated product, such as chlorine bleach, a cleaning solution such as a chlorine dioxide solution, vinyl chloride, polyvinyl chloride, or chlorine gas. Similarly, lithium chloride—calcium chloride salts, used with lithium-conducting solid electrolytes such as LiSICON or lithium lanthanum zirconium oxide (LLZO, a garnet type lithium conductor) or its derivatives, may be used to produce lithium metal and a chlorinated co-product.

Another example of a metal salt mixture which may be used to produce high purity sodium metal is the Na—S system, which may include various sodium sulfides used alone or as a mixture with each other or with sulfur. Pure sulfur melts at 235° C., while Na—S liquids are available above 250° C. Both single liquid phase compositions or semi-solid compositions may be used, from which sodium metal may be reduced at the cathode of the electrochemical cells using sodium solid electrolytes such as sodium beta alumina. The source material may be correspondingly enriched in sulfur as sulfur is oxidized at the anode, and elemental sulfur may be obtained as a co-product of the cell.

In an aspect, a first metal salt may be converted to a second metal salt, and the second metal salt used as the input material for producing the metal. As an example, NaCl may be reacted with sulfur to generate sodium sulfide, the sodium sulfide subsequently being used in an electrochemical cell to produce at least sodium metal, and sulfur as a co-product.

### Metal Handling

In various embodiments, the metal of the metal-air battery, present as a solid or a liquid, may be combined with a protective fluid to provide easier and safer handling, storage, or delivery of the metal to the power-producing metal-air battery. The protective fluid is preferably inert, meaning it has limited reactivity when in contact with the metal. The protective fluid may be hydrophobic or hydrophilic, and may be wetting or non-wetting to the surface of the metal. In a preferred embodiment, the protective fluid is non-reactive and wetting at the surface of the metal. Non-limiting examples of the protective fluid include hydrocarbon oils, silicone oils, ionic liquids, polymers, an emulsion thereof, or a gel thereof. The metal may be in a form of suspended particles in the protective fluid.

The protective liquid may have a density greater than that of the metal, and the metal may thus float as a solid or liquid on the surface of the protective fluid, or the metal may have a density less than the density of the metal, and the solid or liquid metal may sink in the protective fluid and to be covered by the protective fluid. The protective fluid may serve the role of protecting the metal, whether solid or liquid, from exposure to an atmosphere. As illustrated in FIG. 9, the protective fluid may float on top of solid or liquid metal, by virtue of having density less than the metal, to form the protective layer.

Without wishing to be bound to theory, an advantage of Na and denser metals over Li metal is that solid Li metal has a density of 0.5 grams per cubic centimeter (g/cm³), and therefore there are fewer non-reactive liquids to select from that have density less than lithium, and thus a protective layer comprising mineral oil or a hydrocarbon will not float on top of the solid or liquid metal. Na metal has a higher density, facilitating the protection scheme in FIG. 9 because it will sink in many available oils. Crude petroleum oil has a density of 0.8 to 0.9 g/cm³, silicone oils have densities ranging from 0.74 g/cm³ to 1.06 g/cm³, mineral oil and paraffin both have a density of about 0.8 g/cm³, kerosene and diesel fuel have a density of 0.8 g/cm³, and gasoline has a density of 0.74 g/cm³. Solid Na metal has a density of 0.97 g/cm³ at room temperature and 0.95 g/cm³ at the melting point, and liquid Na metal has a density of 0.93 g/cm³ at the melting point to 0.86 g/cm³ at 400° C. Thus there are multiple choices of hydrophobic oils having a density less Na, and thus solid or liquid Na metal will sink and be protected from exposure to atmosphere. In an aspect, a combination of protective fluids may be used to provide a layered protective layer. The combination of solid or liquid metal and the protective liquid may be layered, as shown in FIG. 9. FIG. 9 is a schematic cross-sectional view of a system comprising a metal-air battery comprising a liquid sodium metal electrode floating on top of a non-reactive liquid of higher density than the liquid sodium. Said sodium may be introduced to the system as liquid or as solid sodium, and at any vertical point of the vessel, provided the temperature at the top of the non-reactive liquid is above the melting point of the metal.

In an aspect the metal may be present as droplets or particles having a smallest cross sectional dimension ranging from 1 micrometer (μm) to 1 meter (m), preferably from 10 μm to 0.1 m, and still preferably from 100 μm to 0.01 mm. Such metal may be immersed in the protective fluid, or may be wetted by or coated with the protective fluid. The volume ratio of the protective fluid to the metal may range from 0.001 to 10, or 0.01 to 1. The ratio of the protective fluid to the metal may be selected to provide a stored form of the metal, and the ratio may be suitable for the metal electrode of the metal-air battery. The metal may be initially in the solid state, including but not limited to a configuration including pieces of the solid metal immersed in the protective fluid. The metal may be stored or delivered to the metal-air battery, and heated to melt the metal and form a liquid metal electrode of the battery. Also discloses a configuration in which the metal is directed to the battery as a liquid, and cooled and solidified prior to its use as the metal electrode of the battery.

In an aspect, the metal electrode may be floated on top of a liquid of greater density, e.g., in order to facilitate delivery of the metal to the metal-air battery, or to facilitate delivery of the metal to the electrolyte-air electrode subassembly. As illustrated in FIG. 9, the metal, when floated on top of the protective liquid, may be held using the force of buoyancy in contact with the electrolyte-gas electrode assembly. To charge the battery, the metal may be introduced as a solid, including for example solid pieces, or as a liquid. Due to the lower density of Li metal, numerous higher density liquids as described earlier may be used. Denser oils, on which Li, Na, or K metal (K metal has a density of about 0.86 g/cm³) will float, are also known. A non-limiting example includes the heavy silicone oil known as Densiron 68, which has a density of about 1.06 g/cm³ at room temperature (25° C. (298 K)), which is greater than the density of the alkali metals Li, Na, and K.

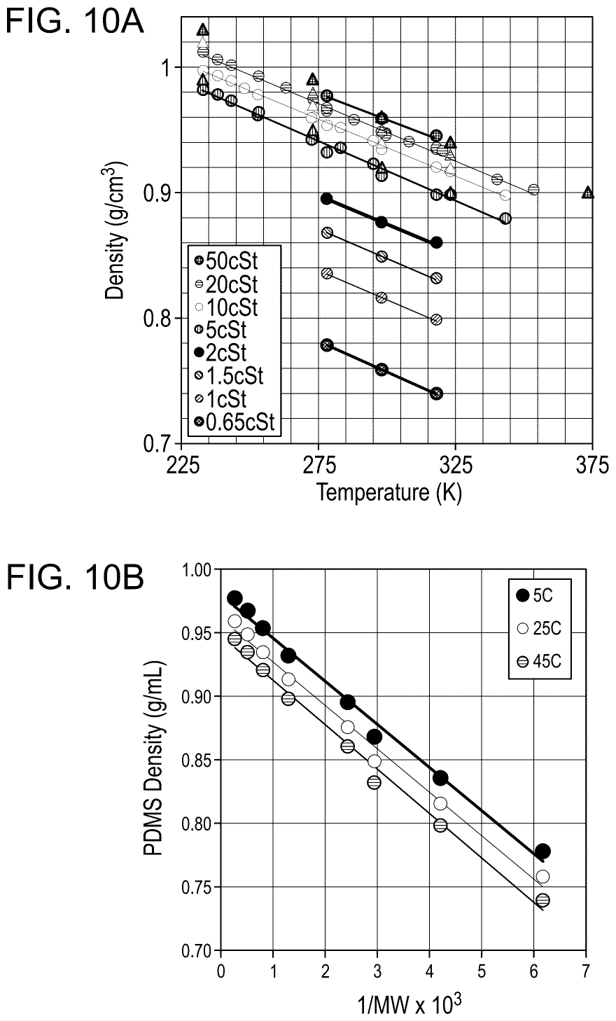

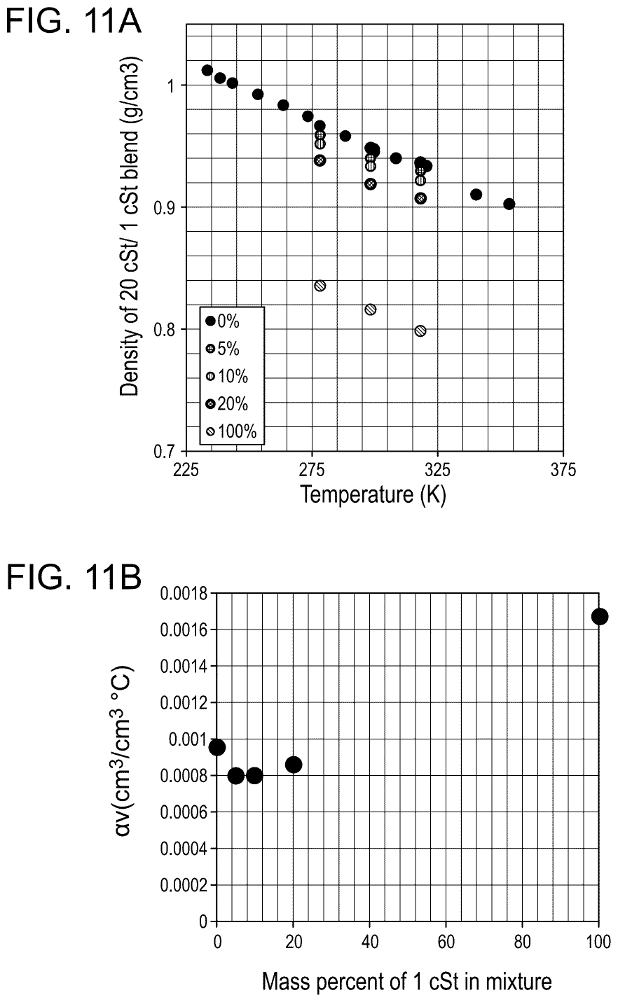

In yet another embodiment, the protective liquid is selected to have a density intermediate between the density of the solid metal and the density of the liquid metal. Taking solid and liquid sodium metal as an example, liquid sodium metal will float, and solid sodium metal will sink, in a protective liquid having a density of about 0.94 g/cm³. Such liquids include but are not limited to silicone oils, e.g., based on polydimethylsiloxane (PDMS), of various average molecular weights. FIG. 10A-B shows the density of various silicone fluids and its variation with temperature, wherein the results are reproduced from C. Roberts, A. Graham, M. Nemer, L. Phinney, R. Garcia, and E. Stirrup, “Physical Properties of Low-Molecular Weight Polydimethylsiloxane Fluids,” Sandia Report SAND2017-1242, 2017, the content of which is incorporated herein in its entirety for all purposes. FIG. 11A-B shows the density of mixtures of two silicone fluids and its variation with temperature, wherein the results are reproduced from C. Roberts, A. Graham, M. Nemer, L. Phinney, R. Garcia, and E. Stirrup, “Physical Properties of Low-Molecular Weight Polydimethylsiloxane Fluids,” Sandia Report SAND2017-1242, 2017, the content of which is incorporated herein in its entirety for all purposes. The variation in density with temperature (slope of the lines) is nearly the same for all the fluids. It is evident to those skilled in the art that near the melting point of sodium metal, 371 K, a mixture of a high density silicone fluid such as Densiron 68, with density at 298 K of 1.06 g/cm³, and a lower density silicone fluid can be prepared that has a density of about 0.94 g/cm³, within which solid sodium metal will sink and liquid sodium metal will float. Other fluids which may be used in high density fluid compositions for this purpose include perfluorohexyloctane (F₆H₈), Oxane HD, and silicone oils containing nano silica particles.

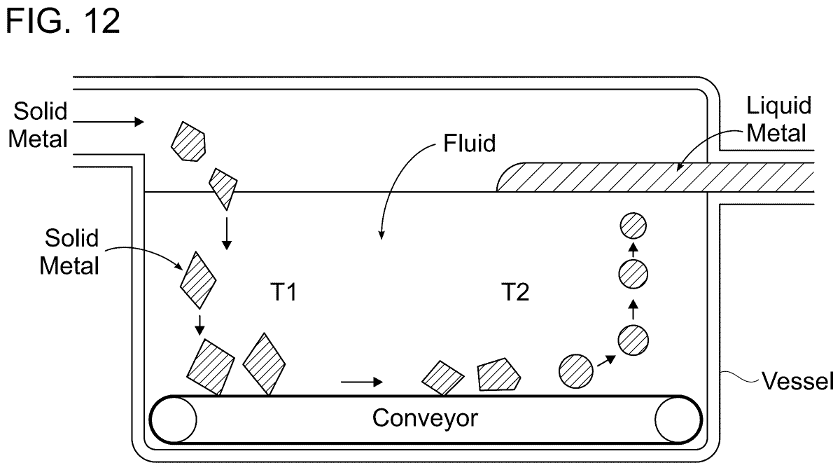

In an aspect, temperature-based density variations are used to safely store or convey a reactive metal such as Li, Na, or K by immersing in a non-reactive fluid at a temperature where the metal has a higher density than the fluid. The fluid or vessel may be heated to another temperature where the metal has a lower density than the fluid, causing it to float on the fluid for the purpose of feeding the metal to the battery or fuel cell. A device or system comprising a vessel, said fluid, and said metal, such as that illustrated in FIG. 9, may be heated and cooled to accomplish these functions. In other aspect, the vessel may have a variation in temperature across it as illustrated in FIG. 12. At one location, the temperature, T1, is below the melting point of the metal. At another location of the vessel, the temperature, T2, is above the melting temperature of the metal. The metal may be stored in the region at temperature T1, where it is solid and safely stored beneath the liquid, and conveyed to the region at temperature T2, where it melts and floats to the surface. Devices or systems with this operating principle may comprise a metal storage and delivery system for handling highly reactive metals such as Li, Na, or K, for any purpose, including but not limited to the batteries or fuel cells of the invention.

### Thermochemical Formation of the Metal Used as a Metal Electrode of the Battery or Fuel Cell

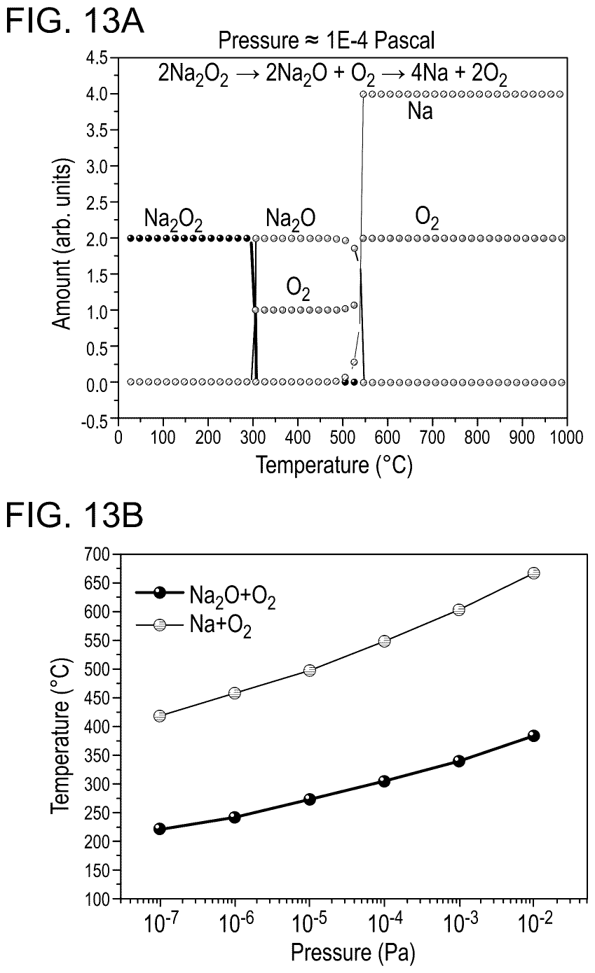

The metal of the metal-air battery or fuel cell may be produced electrolytically, as described earlier, or may be produced thermochemically from a metal salt. In an aspect, the metal salt is a discharge product of the battery or fuel cell. A non-limiting example of a thermochemical method is the decomposition of a sodium oxide to sodium metal. Na₂O₂ and Na₂O are known discharge products of a sodium-air battery. As illustrated in FIG. 13A-B, the thermal decomposition of these oxides to sodium metal and oxygen may proceed as:

2Na₂O₂→2Na₂O+O₂

2Na₂O→4Na+O₂

at temperatures and pressures which may be determined using thermodynamic calculations or experiments known to those skilled in the art. Such data are available from published reports, an example of which is “Analysis of sodium generation by sodium oxide decomposition on corrosion resistant materials: a new approach towards sodium redox water splitting cycle,” by R. Kumar, H. Miyaoka, K. Shinzato, and T. Ichikawa, R S C Adv. 2021, 11, 2017, as reproduced in FIG. 13A-B, the content of which is incorporated herein in its entirety for all purposes. For example, at an oxygen pressure or partial pressure of 10′ pascal, decomposition of Na₂O to Na metal (liquid) and oxygen occurs at about 550° C., and at an oxygen pressure or partial pressure of 10⁻² pascal, the same decomposition reaction occurs at about 675° C. It is further known that other sodium salts including sodium hydroxide, sodium carbonate, and sodium sulfate will decompose on heating to sodium oxide. Accordingly, a sodium salt may be thermally decomposed to sodium metal and said sodium metal used as the electrode for a battery or fuel cell. In an aspect, said sodium salt is a discharge product of the battery, or a discharge product of the battery which has subsequently reacted to form another sodium salt, including but not limited to sodium hydroxide, sodium carbonate, sodium bicarbonate, or sodium sulfate.

As a non-limiting example, said discharge product of a sodium-air battery of fuel cell may be collected and conveyed to a vessel which is at a temperature and an oxygen partial pressure at which sodium oxide decomposes to sodium metal and oxygen. The temperature may range from as low as 400° C. to as high as the boiling point of sodium metal, which is about 883° C. at 1 atm pressure, or even higher temperature, for example up to about 1600° C., in which instance the sodium metal may be present as a vapor phase and may be condensed as liquid or solid sodium metal and collected for use. The oxygen partial pressure may range from as low as 10⁻⁷ pascal to 1 atm (equal to 10⁵ pascal) or even higher, up to 10 atm. The oxygen partial pressure may be controlled by flowing an inert gas over the sodium salt. Said inert gas may comprise nitrogen, which is advantageous by virtue of its abundance and low cost, and the fact that sodium nitride does not readily form. Said inert gas may also comprise helium, argon, hydrogen, carbon dioxide, and other gases which at the temperature and pressure of the vessel does not substantially react with sodium metal.

This disclosure further encompasses the following embodiments.

Embodiment 1: A metal-air battery comprising: a current collector; a metal electrode comprising a metal and contacting the current collector; an air electrode on the metal electrode and opposite the current collector; a solid electrolyte between the metal electrode and the air electrode; a discharge product of the metal on the air electrode; wherein the metal-air battery is configured to release the discharge product.

Embodiment 2: The metal-air battery of embodiment 1, wherein the metal electrode comprises a metal, and the metal is an alkali metal, an alkaline earth metal, or a combination thereof.

Embodiment 3: The metal-air battery of any of embodiments 1-2, wherein the metal is sodium.

Embodiment 4: The metal-air battery of any of embodiments 1-3, wherein the solid electrolyte is in a form of a vessel, and the metal is disposed on an inside of the vessel.

Embodiment 5: The metal-air battery of embodiment 4, wherein the air electrode is disposed on an outside of the vessel, and the discharge product is disposed on the air electrode.

Embodiment 6: The metal-air battery of any of embodiments 1-5, wherein the solid electrolyte is in a form of a tube, and the metal is disposed on an outside of the tube.

Embodiment 7: The metal-air battery of embodiment 6, wherein the air electrode is disposed on an outside of the tube, and the discharge product is disposed on the air electrode.

Embodiment 8: The metal-air battery of embodiment 7, wherein the tube is configured to receive a fluid, and release the discharge product when contacted by the fluid.

Embodiment 9: The metal-air battery of any of embodiments 1-8, wherein the metal is a liquid, and further comprising a protective layer on the metal electrode.

Embodiment 10: The metal-air battery of any of embodiments 6-8, wherein the protective layer comprises an oil or an ionic liquid.

Embodiment 11: The metal-air battery of any of embodiments 7-8, wherein the oil is a hydrocarbon oil, a silicone oil, or a combination thereof, and wherein the oil has a density of 0.8 to 1.06 g/cm³.

Embodiment 12: A system comprising the battery of any of embodiments 1-11, wherein the system comprises an electric vehicle.

Embodiment 13: The system of embodiment 12, wherein the vehicle is an electric air vehicle.

Embodiment 14: The system of any of embodiments 12-13, wherein the electric air vehicle is configured to emit the discharge product.

Embodiment 15: An electric air vehicle system comprising: an electric air vehicle; and a metal-air battery comprising a current collector; a metal electrode comprising an alkali metal and contacting the current collector; an air electrode on the metal electrode and opposite the current collector; a solid electrolyte between the metal electrode and the air electrode; wherein the metal-air battery is configured to release the discharge product; and wherein the electric air vehicle is configured to emit the discharge product.

Embodiment 16: A system for collecting a discharge product of the metal-air battery of any of embodiments 1-14, wherein the air electrode is configured to receive a fluid and release the discharge product when contacted by the fluid.

Embodiment 17: The system of embodiment 16, wherein the fluid comprises air, an aqueous fluid, a non-aqueous fluid, or a combination thereof.

Embodiment 18: A method for converting a metal-air battery discharge product to a metal, the method comprising: providing a discharge product of a metal-air battery; contacting the discharge product with a liquid to form a brine; disposing the brine in an electrolysis cell comprising a solid electrolyte; electrodepositing a metal from the brine to convert the metal-air battery discharge product to a metal.

Embodiment 19: The method of embodiment 18, wherein the electrodepositing deposits the metal on a current collector.

Embodiment 20: The method of embodiment 19, wherein the current collector is the current collector of a metal-air battery, and the metal-air battery comprises: the current collector; a metal electrode comprising the metal and contacting the current collector, an air electrode on the metal electrode and opposite the current collector; a solid electrolyte between the metal electrode and the air electrode; wherein the metal-air battery is configured to release the discharge product.

Embodiment 21: The method of any of embodiments 18-19, wherein the solid electrolyte has an ionic transference number for the metal greater than 0.9, preferably 0.95 to 0.999, and wherein the electrodeposited metal has a purity of at least 99.9%, based on a total metal content.

Embodiment 22: A method of collecting a discharge product of a metal-air battery, the method comprising: providing a metal-air battery configured to release a discharge product; flushing an air electrode of the metal-air battery with a gas stream to remove the discharge product from the air electrode and provide a discharge product entrained gas stream, or flushing an air electrode of the metal-air battery with liquid to remove the discharge product from the air electrode and provide a solution comprising the discharge product to collect the discharge product.

Embodiment 23: The method of embodiment 22, wherein the gas stream comprises a gas inert to the discharge product.

Embodiment 24: The method of embodiment 23, wherein the gas comprises nitrogen, argon, helium, hydrogen, or a combination thereof.

Embodiment 25: The method of any of embodiments 22-23, wherein the gas stream comprises a gas that is reactive to the discharge product.

Embodiment 26: The method of embodiment 25, wherein the gas comprises water, carbon monoxide, carbon dioxide, or a combination thereof.

Embodiment 27: The method of any of embodiments 22-26, further comprising contacting the discharge product on the air electrode with water, an aqueous solution, or a non-aqueous solution to provide a solution comprising the discharge product.

Embodiment 28: The method of any of embodiments 22-27, further comprising treating the air electrode with a fluid.

Embodiment 29: The method of embodiment 28, wherein fluid comprises a dry gas.

Embodiment 30: The method of any of embodiments 22-29, further comprising discharging the battery before the flushing, after the flushing, or both before and after the flushing.

Embodiment 31: The method of any of embodiments 22-30, further comprising discharging the battery and the flushing is continuous during discharge, or wherein further comprising discharging the battery and the flushing is intermittent during discharge.

Embodiment 32: The method of any of embodiments 22-31, wherein the battery is installed in a device powered by the battery, and the flushing occurs while the battery is installed.

Embodiment 33: The method of any of embodiments 22-32, further comprising removing the battery before the flushing.

Embodiment 34: The method of any of embodiments 22-33, further comprising removing a component comprising an air electrode of the battery from a device powered by the battery, and the flushing the air electrode.

Embodiment 35: A method for processing a discharge product of metal-air battery, the method comprising: providing a discharge product from a metal-air battery; contacting the collected discharge product with water to form a brine comprising a metal ion of a metal of the metal-air battery; disposing the brine in an electrodeposition cell in contact with an electrolyte conductive to the metal ion; and reducing the metal ion on a current collector to form the metal of the metal-air battery and process the discharge product.

Embodiment 36: The method of embodiment 35, wherein the discharge product comprises a hydroxide, oxide, carbonate, bicarbonate, or oxalate of the metal of the metal-air battery, or a combination thereof.

Embodiment 37: The method of any of embodiments 35-36, wherein the brine has a metal ion concentration of 0.01 to 10 moles per liter.

Embodiment 38: The method of any of embodiments 35-37, wherein the electrolyte comprises a solid oxide electrolyte, a solid polymer electrolyte, a molten salt, or a combination thereof.

Embodiment 39: The method of any of embodiments 35-38, wherein the metal is electrodeposited between the current collector and the electrolyte.

Embodiment 40: The method of embodiment 36, further comprising disposing an air electrode on the electrolyte.

Embodiment 41: The method of any of embodiments 35-40, further comprising converting the discharge product to a halide, and electrolytically decomposing the halide to form the metal and a halogen.

Embodiment 42: The method of embodiment 41, wherein the metal is lithium, sodium, or a combination thereof, and the halogen is chlorine.

Embodiment 43: The method of embodiment 42, wherein the halide is lithium chloride, sodium chloride, or combination thereof.

Embodiment 44: A method for manufacturing a metal-air battery, the method comprising: collecting a discharge product from a metal-air battery; contacting the collected discharge product with water to form a brine comprising a metal ion of a metal of the metal-air battery; disposing the brine in an electrodeposition cell in contact with an electrolyte conductive to the metal ion; reducing the metal ion on a current collector to form the metal of the metal-air battery on the current collector; and disposing an air electrode on the electrolyte to manufacture the metal-air battery, wherein the collecting comprises the method of collecting a discharge product of any of embodiments 22-35 of the metal-air battery.

Embodiment 45: A method for manufacturing a battery, the method comprising: collecting a discharge product from a metal-air battery; contacting the collected discharge product with water to form a brine comprising a metal ion of a metal of the battery; disposing the brine in an electrodeposition cell in contact with an electrolyte conductive to the metal ion; reducing the metal ion on a current collector to form the metal of the battery on the current collector; and disposing an electrode comprising an intercalation compound on the electrolyte to manufacture the battery.

Embodiment 46: The method of embodiment 45, wherein the collecting comprises the method of collecting a discharge product of a metal-air battery of any of embodiments 22-35.

Embodiment 47: The method of any of embodiments 45-46, wherein the intercalation compound is an oxide, a phosphate, a carbon, or a combination thereof.

Embodiment 48: The method of embodiment 47, wherein intercalation compound comprises graphite, hard carbon, silicon, or a combination thereof, and the electrode is a negative electrode for a lithium battery.

Embodiment 49: A method for manufacturing a metal-air battery, the method comprising: providing a current collector; disposing a precursor to the solid electrolyte on the current collector; treating the precursor to form the solid electrolyte; contacting the solid electrolyte with a liquid containing metal ions of a metal of the metal-air battery; reducing the metal ions to electrodeposit the metal on the current collector; and disposing an air electrode on the electrolyte to manufacture the metal-air battery.

Embodiment 50: The method of embodiment 49, wherein the precursor comprises metal nitrates, sulfates, carbonates, oxalates, acetates, alkoxides, or a combination thereof.

Embodiment 51: The method of any of embodiments 49-50, wherein the treating comprises irradiation with radiation having a wavelength in the range of microwaves to gamma rays.

Embodiment 52: The method of any of embodiments 49-51, further comprising irradiating the solid electrolyte to densify the solid electrolyte.

Embodiment 53: The method of any of embodiments 50, wherein the densifying comprises irradiation with radiation having a wavelength in the range of microwaves to gamma rays.

Embodiment 54: The method of any of embodiments 49-53, wherein the liquid containing metal ions is aqueous or non-aqueous.

Embodiment 55: The method of any of embodiments 53-54, wherein the liquid is an aqueous metal salt solution.

Embodiment 56: The method of any of embodiments 53-55, wherein the liquid is an ionic liquid, a molten metal salt, or a combination thereof.

Embodiment 57: The method of any of embodiments 49-56, wherein the metal ions comprise alkali metal ions, alkaline earth metal ions, or a combination thereof.

Embodiment 58: The method of any of embodiments 56-57, wherein the metal ions are sodium ions, and the metal is sodium.

Embodiment 59: The method of any of embodiments 56-58, further comprising after the reducing, removing the current collector with the metal and the solid electrolyte from an apparatus for electrodepositing the metal.

Embodiment 60: A method for manufacturing a metal-air battery, the method comprising: providing a current collector; disposing a solid electrolyte on the current collector; irradiating the solid electrolyte to densify the solid electrolyte; contacting the solid electrolyte with a liquid containing metal ions of a metal of the metal-air battery; reducing the metal ions to electrodeposit the metal on the current collector; and disposing an air electrode on the electrolyte to manufacture the metal-air battery.

Embodiment 61: An electric vehicle comprising the metal-air battery or the methods of manufacturing the metal-air battery of any of the embodiments 1-60.

Embodiment 62: The electric vehicle of any of embodiments 1-61, wherein the electric vehicle is an air vehicle.

Embodiment 63: The electric vehicle of any of embodiments 1-62, wherein the discharge product is released from the vehicle as the vehicle is propelled.

Embodiment 64: The electric vehicle of embodiment 63, wherein the discharge product is flushed from the air electrode by a gas stream comprising air.

Embodiment 65: A method of carbon sequestration, the method comprising: operating the electric vehicle of any of embodiments 1-64; contacting the air electrode with air to form the discharge product, wherein the air comprises carbon dioxide, and the discharge product comprises a carbonate, a bicarbonate, or a combination thereof; and emitting the discharge product to sequester the carbon.

Embodiment 66: The method of embodiment 65, wherein the metal-air battery is a sodium-air battery, and the discharge product is sodium carbonate, sodium bicarbonate, or a combination thereof.

Embodiment 67: A system comprising electrolysis cell for electrolytically producing a metal and a metal-air battery comprising the metal, the system comprising: a metal-air battery comprising a current collector, a metal electrode comprising a metal and contacting the current collector, an air electrode on the metal electrode, a first solid electrolyte between the metal electrode and the air electrode; and an electrolysis cell comprising a brine vessel configured to contain a brine comprising a metal ion of the metal, a second solid electrolyte between the brine vessel and the metal electrode of the metal-air battery, a cathode of the electrolysis cell on a side of the second solid electrolyte opposite the brine vessel, an anode of the electrolysis cell contacting in the brine vessel and opposite the second solid electrolyte.

Embodiment 68: The system of embodiment 67, wherein the metal is sodium, and further comprising a protective layer on the metal electrode, wherein the protective layer is an oil having a density of 0.8 to 1.06 g/cm³.

Embodiment 69: A method for electrolytically producing a metal and using the metal in a metal-air battery, the method comprising: providing a system comprising a metal-air battery comprising a current collector, a metal electrode comprising a metal and contacting the current collector, an air electrode on the metal electrode, and a first solid electrolyte between the metal electrode and the air electrode, and an electrolysis cell comprising a brine contained in the brine vessel, the brine comprising a metal ion of the metal, a second solid electrolyte between the brine and the metal electrode of the metal-air battery, a cathode of the electrolysis cell on a side of the second solid electrolyte opposite the brine vessel, an anode of the electrolysis cell contacting in the brine and opposite the second solid electrolyte, providing a voltage between the cathode of the electrolysis cell and the anode of the electrolysis cell to transport a metal ion from the brine and form a metal of the metal ion on the cathode of the electrolysis cell; and contacting the air electrode with air to convert the metal on the cathode and in the air battery to a discharge product and use the metal.

Embodiment 70: A method of charging a metal-air battery, the method comprising: providing a metal-air battery comprising a solid electrolyte between an air electrode and a metal electrode, and a protective fluid on the metal electrode and opposite the solid electrolyte, wherein the protective fluid and the metal electrode are contained in a container having an upper inlet and a lower inlet; and adding the metal through at least one of the upper inlet or a lower inlet to charge the metal-air battery.

Embodiment 71: The method of embodiment 70, wherein the metal is sodium and the protective fluid is an oil.

Embodiment 72: The method of embodiment 71, further comprising providing the sodium by providing sodium oxide, heating the sodium oxide in a vacuum to convert the sodium oxide to sodium and oxygen, and directing the sodium to the metal-air battery to provide the sodium.

Embodiment 73: A method of operating a metal-air battery, the method comprising: providing a metal-air battery comprising a solid electrolyte between an air electrode and a metal electrode, and a protective fluid on the metal electrode and opposite the solid electrolyte, wherein the protective fluid and the metal electrode are contained in a container having an upper inlet and a lower inlet; and heating the metal to float the metal on the protective fluid, or cooling the metal to sink the metal in the protective fluid to operate the metal-air battery.

Embodiment 74: The method of embodiment 73, wherein the metal is sodium and the protective fluid is an oil.

Embodiment 75: A system configured to thermochemically producing a metal, the system comprising: a metal salt comprising a discharge product of a metal-air battery; and a vessel configured to control pressure, temperature, atmosphere, or a combination thereof, wherein the vessel comprises an inlet, an outlet, or both.

Embodiment 76: The system of embodiment 75, wherein the metal salt is a sodium salt comprising sodium hydroxide, sodium carbonate, sodium bicarbonate, sodium sulfate, sodium oxide, or a combination thereof.

Embodiment 77: The system of any of embodiments 75-76, further comprising a metal of the metal salt, wherein the metal is a thermochemically produced product of the metal salt.

Embodiment 78: A method of thermochemically producing a metal, the method comprising: providing a metal salt; providing a vessel configured to control pressure, temperature, atmosphere, or a combination thereof, wherein the vessel comprises an inlet, an outlet, or both; disposing the metal salt in the vessel; controlling the pressure, the temperature, the atmosphere, or a combination thereof, to thermochemically decompose the metal salt to produce the metal.

Embodiment 79: The method of embodiment 78, further comprising disposing the metal on a current collector to provide a metal electrode subassembly.

Embodiment 80: The method of any of embodiments 78-79, wherein the metal salt is a sodium salt comprising sodium hydroxide, sodium carbonate, sodium bicarbonate, sodium sulfate, sodium oxide, or a combination thereof, and the metal is sodium.

Embodiment 81: The method of any of embodiments 78-80, wherein the pressure is oxygen partial pressure, and the oxygen partial pressure is 10⁻⁷ to 10⁵ pascal.

Embodiment 82: The method of any of embodiments 78-81, wherein the temperature is 400° C. to 1600° C.

Embodiment 83: The method of any of embodiments 78-82, wherein the atmosphere comprises an inert gas, wherein the inert gas is transported through the inlet, the outlet, or both.

Embodiment 84: The method of embodiment 83, wherein the inert gas comprises helium, argon, hydrogen, carbon dioxide, or a combination thereof.

The compositions, methods, and articles can alternatively include, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination including at least one of the listed components or properties optionally together with a like or equivalent component or property not listed.

It will be understood that when an element is referred to as being “on” another element, it can be directly on the other element or intervening elements may be present therebetween. In contrast, when an element is referred to as being “directly on” another element, there are no intervening elements present.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A metal-air battery comprising:
a current collector;
a metal electrode comprising a metal and contacting the current collector;
an air electrode on the metal electrode and opposite the current collector;
a solid electrolyte between the metal electrode and the air electrode;
a discharge product of the metal on the air electrode;
wherein the metal-air battery is configured to release the discharge product.

2. The metal-air battery of claim 1, wherein the metal electrode comprises a metal, and the metal is an alkali metal, an alkaline earth metal, or a combination thereof.

3. The metal-air battery of claim 1, wherein the metal is sodium.

4. The metal-air battery of claim 1, wherein the solid electrolyte is in a form of a vessel, and the metal is disposed on an inside of the vessel.

5. The metal-air battery of claim 4, wherein the air electrode is disposed on an outside of the vessel, and the discharge product is disposed on the air electrode.

6. The metal-air battery of claim 1, wherein the solid electrolyte is in a form of a tube, and the metal is disposed on an outside of the tube.

7. The metal-air battery of claim 6, wherein the air electrode is disposed on an outside of the tube, and the discharge product is disposed on the air electrode.

8. The metal-air battery of claim 7, wherein the tube is configured to receive a fluid, and release the discharge product when contacted by the fluid.

9. The metal-air battery of claim 1, wherein the metal is a liquid, a solid, or both, and further comprising a protective layer on the metal electrode.

10. The metal-air battery of claim 6, wherein the protective layer comprises an oil, an ionic liquid, a liquid that is substantially non-reactive with the metal, or a combination thereof.

11. The metal-air battery of claim 7, wherein the oil is a hydrocarbon oil, a silicone oil, or a combination thereof, and wherein the oil has a density of 0.8 to 1.06 g/cm³.

12. A system comprising the battery of claim 1, wherein the system comprises an electric vehicle.

13. The system of claim 12, wherein the electric vehicle is a ground vehicle, air vehicle, water vehicle.

14. The system of claim 12, wherein the electric air vehicle is configured to emit the discharge product.

15. An electric air vehicle system comprising:
an electric air vehicle; and
a metal-air battery comprising
a current collector;
a metal electrode comprising an alkali metal and contacting the current collector;
an air electrode on the metal electrode and opposite the current collector;
a solid electrolyte between the metal electrode and the air electrode;
wherein the metal-air battery is configured to release the discharge product; and
wherein the electric air vehicle is configured to emit the discharge product.

16. A system for collecting a discharge product of the metal-air battery of claim 1, wherein the air electrode is configured to receive a fluid and release the discharge product when contacted by the fluid.

17. The system of claim 16, wherein the fluid comprises a gas, an aqueous fluid, a non-aqueous fluid, or a combination thereof.

18. A method for converting a metal-air battery discharge product to a metal, the method comprising:
providing a discharge product of a metal-air battery;
contacting the discharge product with a liquid to form a brine;
disposing the brine in an electrolysis cell comprising a solid electrolyte;
electrodepositing a metal from the brine to convert the metal-air battery discharge product to a metal, or
providing the discharge product of the metal-air battery;
converting the discharge product to a metal salt;
disposing the metal salt in the electrolysis cell comprising the solid electrolyte;
electrodepositing a metal from the metal salt to convert the metal salt to a metal.

19. The method of claim 18, wherein the electrodepositing deposits the metal on a current collector.

20. The method of claim 19, wherein the current collector is the current collector of a metal-air battery, and the metal-air battery comprises:
the current collector;
a metal electrode comprising the metal and contacting the current collector,
an air electrode on the metal electrode and opposite the current collector;
a solid electrolyte between the metal electrode and the air electrode;
wherein the metal-air battery is configured to release the discharge product.

21. The method of claim 18, wherein the solid electrolyte has an ionic transference number for the metal greater than 0.9, preferably 0.95 to 0.999, and wherein the electrodeposited metal has a purity of at least 90%, based on a total metal content.

22. A method of collecting a discharge product of a metal-air battery, the method comprising:
providing a metal-air battery configured to release a discharge product;
flushing an air electrode of the metal-air battery with a gas stream to remove the discharge product from the air electrode and provide a discharge product entrained gas stream, or flushing an air electrode of the metal-air battery with liquid to remove the discharge product from the air electrode and provide a solution comprising the discharge product to collect the discharge product.

23. The method of claim 22, wherein the gas stream comprises a gas inert to the discharge product.

24. The method of claim 23, wherein the gas comprises nitrogen, argon, helium, hydrogen, or a combination thereof.

25. The method of claim 22, wherein the gas stream comprises a gas that is reactive to the discharge product.

26. The method of claim 25, wherein the gas comprises oxygen, water, carbon monoxide, carbon dioxide, or a combination thereof.

27. The method of claim 22, further comprising contacting the discharge product on the air electrode with water, an aqueous solution, or a non-aqueous solution to provide a solution comprising the discharge product.

28. The method of claim 22, further comprising treating the air electrode with a fluid.

29. The method of claim 28, wherein fluid comprises a dry gas.

30. The method of claim 22, further comprising discharging the battery before the flushing, after the flushing, or both before and after the flushing.

31. The method of claim 22, further comprising discharging the battery and the flushing is continuous during discharge, or wherein further comprising discharging the battery and the flushing is intermittent during discharge.

32. The method of claim 22, wherein the battery is installed in a device powered by the battery, and the flushing occurs while the battery is installed.

33. The method of claim 22, further comprising removing the battery before the flushing.

34. The method of claim 22, further comprising removing a component comprising an air electrode of the battery from a device powered by the battery, and the flushing the air electrode.

35. A method for processing a discharge product of metal-air battery, the method comprising:
providing a discharge product from a metal-air battery;
contacting the collected discharge product with water to form a brine comprising a metal ion of a metal of the metal-air battery;
disposing the brine in an electrodeposition cell in contact with an electrolyte conductive to the metal ion; and
reducing the metal ion on a current collector to form the metal of the metal-air battery and process the discharge product.

36. The method of claim 35, wherein the discharge product comprises a hydroxide, oxide, carbonate, bicarbonate, or oxalate of the metal of the metal-air battery, or a combination thereof.

37. The method of claim 35, wherein the brine has a metal ion concentration of 0.01 to 10 moles per liter.

38. The method of claim 35, wherein the electrolyte comprises a solid oxide electrolyte, a solid polymer electrolyte, a molten salt, or a combination thereof.

39. The method of claim 35, wherein the metal is electrodeposited between the current collector and the electrolyte.

40. The method of claim 36, further comprising disposing an air electrode on the electrolyte.

41. The method of claim 35, further comprising converting the discharge product to a halide, and
electrolytically decomposing the halide to form the metal and a halogen.

42. The method of claim 41, wherein the metal comprises lithium, sodium, or a combination thereof, and the halogen is chlorine.

43. The method of claim 42, wherein the halide is lithium chloride, sodium chloride, or combination thereof.

44. A method for manufacturing a metal-air battery, the method comprising:
collecting a discharge product from a metal-air battery;
contacting the collected discharge product with water to form a brine comprising a metal ion of a metal of the metal-air battery;
disposing the brine in an electrodeposition cell in contact with an electrolyte conductive to the metal ion;
reducing the metal ion on a current collector to form the metal of the metal-air battery on the current collector; and
disposing an air electrode on the electrolyte to manufacture the metal-air battery,
wherein the collecting comprises the method of collecting a discharge product of a metal-air battery of claim 22, or
collecting the discharge product from the metal-air battery;
converting the discharge product to a metal salt;
disposing the metal salt in the electrodeposition cell in contact with an electrolyte conductive to the metal ion;
reducing the metal ion on a current collector to form the metal of the metal-air battery on the current collector; and
disposing the air electrode on the electrolyte to manufacture the metal-air battery, wherein the collecting comprises the method of collecting the discharge product of a metal-air battery of claim 22.

45. A method for manufacturing a battery, the method comprising:
collecting a discharge product from a metal-air battery;
contacting the collected discharge product with water to form a brine comprising a metal ion of a metal of the battery;
disposing the brine in an electrodeposition cell in contact with an electrolyte conductive to the metal ion;
reducing the metal ion on a current collector to form the metal of the battery on the current collector; and
disposing an electrode comprising an intercalation compound on the electrolyte to manufacture the battery, or
collecting the discharge product from the metal-air battery;
converting the discharge product to a metal salt;
disposing the metal salt in the electrodeposition cell in contact with an electrolyte conductive to the metal ion;
reducing the metal ion on a current collector to form the metal of the battery on the current collector; and
disposing the electrode comprising the intercalation compound on the electrolyte to manufacture the battery.

46. The method of claim 45, wherein the collecting comprises the method of collecting a discharge product of a metal-air battery of claim 22.

47. The method of claim 45, wherein the intercalation compound is a oxide, a phosphate, a carbon, or a combination thereof.

48. The method of claim 47, wherein intercalation compound comprises graphite, hard carbon, silicon, or a combination thereof, and the electrode is a negative electrode for a lithium or sodium battery.

49. A method for manufacturing a metal-air battery, the method comprising:
providing a current collector;
disposing a precursor to the solid electrolyte on the current collector;
treating the precursor to form the solid electrolyte;
contacting the solid electrolyte with a source of metal ions of a metal of the metal-air battery;
reducing the metal ions to electrodeposit the metal on the current collector; and
disposing an air electrode on the electrolyte to manufacture the metal-air battery.

50. The method of claim 49, wherein the precursor comprises metal nitrates, sulfates, carbonates, oxalates, acetates, alkoxides, or a combination thereof.

51. The method of claim 49, wherein the treating comprises heating, irradiation with radiation having a wavelength in the range of microwaves to gamma rays, or a combination thereof.

52. The method of claim 49, further comprising heating, irradiating with radiation having a wavelength in the range of microwaves to gamma rays, or a combination thereof, the solid electrolyte to densify the solid electrolyte.

53. The method of claim 50, wherein the densifying comprises irradiation with radiation having a wavelength in the range of microwaves to gamma rays.

54. The method of claim 49, wherein the liquid containing metal ions is aqueous or non-aqueous.

55. The method of claim 54, wherein the liquid is an aqueous metal salt solution.

56. The method of claim 54, wherein the liquid is an ionic liquid, a molten metal salt, or a combination thereof.

57. The method of claim 49, wherein the metal ions comprise alkali metal ions, alkaline earth metal ions, or a combination thereof.

58. The method of claim 56, wherein the metal ions are sodium ions, and the metal is sodium.

59. The method of claim 56, further comprising after the reducing, removing the current collector with the metal and the solid electrolyte from an apparatus for electrodepositing the metal.

60. A method for manufacturing a metal-air battery, the method comprising:
providing a current collector;
disposing a solid electrolyte on the current collector;
irradiating the solid electrolyte to densify the solid electrolyte;
contacting the solid electrolyte with a liquid containing metal ions of a metal of the metal-air battery;
reducing the metal ions to electrodeposit the metal on the current collector; and
disposing an air electrode on the electrolyte to manufacture the metal-air battery.

61. An electric vehicle comprising the metal-air battery of claim 1.

62. The electric vehicle of claim 61, wherein the electric vehicle is an air vehicle.

63. The electric vehicle of claim 61, wherein the discharge product is released from the vehicle as the vehicle is propelled.

64. The electric vehicle claim 63, wherein the discharge product is flushed from the air electrode by a gas stream comprising air.

65. A method of carbon sequestration, the method comprising:
operating the electric vehicle of claim 61;
contacting the air electrode with air to form the discharge product, wherein the air comprises carbon dioxide, and the discharge product comprises a carbonate, a bicarbonate, or a combination thereof; and
emitting the discharge product to sequester the carbon.

66. The method of claim 65, wherein the metal-air battery is a sodium-air battery, and the discharge product comprises sodium oxide, sodium hydroxide, sodium carbonate, sodium bicarbonate, or a combination thereof.

67. A system comprising electrolysis cell for electrolytically producing a metal and a metal-air battery comprising the metal, the system comprising:
a metal-air battery comprising
a current collector,
a metal electrode comprising a metal and contacting the current collector,
an air electrode on the metal electrode,
a first solid electrolyte between the metal electrode and the air electrode; and
an electrolysis cell comprising
a vessel configured to contain a metal ion source comprising a metal ion of the metal,
a second solid electrolyte between the vessel and the metal electrode of the metal-air battery,
a cathode of the electrolysis cell on a side of the second solid electrolyte opposite the vessel,
an anode of the electrolysis cell contacting in the vessel and opposite the second solid electrolyte.

68. The system of claim 67, wherein the metal is sodium, and further comprising a protective layer on the metal electrode, wherein the protective layer is an oil having a density of 0.8 to 1.06 g/cm³.

69. A method for electrolytically producing a metal and using the metal in a metal-air battery, the method comprising:
providing a system comprising
a metal-air battery comprising
a current collector,
a metal electrode comprising a metal and contacting the current collector,
an air electrode on the metal electrode, and
a first solid electrolyte between the metal electrode and the air electrode, and
an electrolysis cell comprising
a vessel configured to contain a metal ion source comprising a metal ion of the metal,
a second solid electrolyte between the vessel and the metal electrode of the metal-air battery,
a cathode of the electrolysis cell on a side of the second solid electrolyte opposite the vessel,
an anode of the electrolysis cell contacting in the vessel and opposite the second solid electrolyte,
providing a voltage between the cathode of the electrolysis cell and the anode of the electrolysis cell to transport a metal ion from the brine and form a metal of the metal ion on the cathode of the electrolysis cell; and
contacting the air electrode with air to convert the metal on the cathode and in the air battery to a discharge product and use the metal.

70. A method of charging a metal-air battery, the method comprising:
providing a metal-air battery comprising
a solid electrolyte between an air electrode and a metal electrode, and
a protective fluid on the metal electrode and opposite the solid electrolyte,
wherein the protective fluid and the metal electrode are contained in a container having an upper inlet and a lower inlet; and
adding the metal through at least one of the upper inlet or a lower inlet to charge the metal-air battery.

71. The method of claim 70, wherein the metal is sodium and the protective fluid is an oil.

72. The method of claim 71, further comprising providing the sodium by providing sodium hydroxide, sodium carbonate, sodium bicarbonate, sodium sulfate, sodium oxide, or a combination thereof,
heating the sodium hydroxide, sodium carbonate, sodium bicarbonate, sodium sulfate, sodium oxide, or a combination thereof, in a vacuum to convert the sodium oxide to sodium and a gas comprising oxygen, carbon dioxide, sulfur dioxide, water, or a combination thereof, and
directing the sodium to the metal-air battery to provide the sodium.

73. A method of operating a metal-air battery, the method comprising:
providing a metal-air battery comprising
a solid electrolyte between an air electrode and a metal electrode, and
a protective fluid on the metal electrode and opposite the solid electrolyte, wherein the protective fluid and the metal electrode are contained in a container having an upper inlet and a lower inlet; and
heating the metal to float the metal on the protective fluid, or cooling the metal to sink the metal in the protective fluid to operate the metal-air battery.

74. The method of claim 73, wherein the metal is sodium and the protective fluid is an oil.

75. A system configured to thermochemically producing a metal, the system comprising:
a metal salt comprising a discharge product of a metal-air battery; and
a vessel configured to control pressure, temperature, atmosphere, or a combination thereof,
wherein the vessel comprises an inlet, an outlet, or both.

76. The system of claim 75, wherein the metal salt is a sodium salt comprising sodium hydroxide, sodium carbonate, sodium bicarbonate, sodium sulfate, sodium oxide, or a combination thereof.

77. The system of claim 75, further comprising a metal of the metal salt, wherein the metal is a thermochemically produced product of the metal salt.

78. A method of thermochemically producing a metal, the method comprising:
providing a metal salt;
providing a vessel configured to control pressure, temperature, atmosphere, or a combination thereof,
wherein the vessel comprises an inlet, an outlet, or both;
disposing the metal salt in the vessel;
controlling the pressure, the temperature, the atmosphere, or a combination thereof, to thermochemically decompose the metal salt to produce the metal.

79. The method of claim 78, further comprising disposing the metal on a current collector to provide a metal electrode subassembly.

80. The method of claim 78, wherein the metal salt is a sodium salt comprising sodium hydroxide, sodium carbonate, sodium bicarbonate, sodium sulfate, sodium oxide, or a combination thereof, and the metal is sodium.

81. The method of claim 78, wherein the pressure is oxygen partial pressure, and the oxygen partial pressure is 10⁻⁷ to 10⁵ pascal.

82. The method of claim 78, wherein the temperature is 400° C. to 1600° C.

83. The method of claim 78, wherein the atmosphere comprises an inert gas, wherein the inert gas is transported through the inlet, the outlet, or both.

84. The method of claim 83, wherein the inert gas comprises nitrogen, helium, argon, hydrogen, carbon dioxide, or a combination thereof.

85. The metal-air battery of claim 1, wherein the air electrode is in contact with a second current collector.

86. The system of claim 12, wherein the electric vehicle is a car, truck, train, helicopter, unmanned air vehicle, drone, plane, vertical takeoff and landing (VTOL) craft, boat, ship, barge, or tugboat.

87. The metal-air battery of claim 15, wherein the air electrode is in contact with a second current collector.

88. The system of claim 17, wherein the gas is air, nitrogen, CO₂, or a combination thereof.

89. The method of claim 18, wherein the metal salt comprises a metal halide, a metal sulfide, or a combination thereof.

90. The method of claim 89, wherein the metal salt is further converted to NaSICON, Na-beta″ alumina, or both.

91. The method of claim 20, wherein the air electrode is in contact with a second current collector.

92. A method for processing a discharge product of metal-air battery, the method comprising:
providing a discharge product from a metal-air battery;
contacting the collected discharge product with water to form a brine comprising a metal ion of the metal of the metal-air battery;
converting the brine to produce metal hydroxides, metal carbonates, metal bicarbonates, metal halides, or a combination thereof.

93. The method of claim 92, wherein the metal hydroxides, or metal carbonates, comprise LiOH, Li₂CO₃, NaOH, or Na₂CO₃.

94. The method of claim 92, further comprising converting the metal hydroxides, metal carbonates, metal bicarbonates, metal halides, to produce battery electrode compounds or solid electrolytes.

95. The method of claim 94, wherein the metal halide is LiF, and is converted to LiPF₆.

96. The method of claim 49, wherein the source comprises a liquid, a solid, or a vapor.

97. The method of claim 96, wherein the liquid comprises brine, molten metal halides, molten metal sulfides, or a combination thereof.

98. The electric vehicle of claim 61, wherein the discharge product is removed from the air electrode, and optionally is stored in a vessel as a solid or a liquid.

99. The system of claim 67, wherein the electrolysis cell further comprises
a brine vessel configured to contain a brine comprising a metal ion of the metal,
the second solid electrolyte between the brine vessel and the metal electrode of the metal-air battery,
the cathode of the electrolysis cell on a side of the second solid electrolyte opposite the brine vessel,
the anode of the electrolysis cell contacting in the brine vessel and opposite the second solid electrolyte.

100. The system of claim 67, wherein the metal ion source comprises metal chloride, metal sulfide, or a combination thereof.

101. The system of claim 69, wherein the metal ion source comprises metal chloride, metal sulfide, or a combination thereof.

102. A combined system comprising:
the system of claim 1, the system of claim 67, the system of claim 69, the system of claim 75, or a combination thereof.
